(19) United States
(12) Patent Application Publication
(10) Pub. No.: US 2026/0095201 A1
(43) Pub. Date: Apr. 2, 2026

(54) APPARATUSES, SYSTEMS, AND METHODS FOR ANTENNA PERFORMANCE ADJUSTMENT BASED ON WEARABLE DEVICE DETECTED LOAD DISTRIBUTION

(71) Applicant: Meta Platforms Technologies, LLC, Menlo Park, CA (US)

(72) Inventors: Md Rashidul ISLAM, Union City, CA (US); Joung Sub SHIN, Sunnyvale, CA (US); Chia-Wei LIU, Newark, CA (US); Eduardo Jorge Da Costa Bras LIMA, Santa Clara, CA (US); Liang HAN, Sunnyvale, CA (US)

(73) Assignee: Meta Platforms Technologies, LLC, Menlo Park, CA (US)

(21) Appl. No.: 19/345,964

(22) Filed: Sep. 30, 2025

Related U.S. Application Data
(63) Continuation-in-part of application No. 18/980,979, filed on Dec. 13, 2024.
(60) Provisional application No. 63/701,786, filed on Oct. 1, 2024.

(51) Int. Cl. H04B 1/3827; G01L 5/04; H01Q 1/27; H01Q 5/335

(52) U.S. Cl. CPC H04B 1/385; G01L 5/04; H01Q 1/273; H01Q 5/335; H04B 2001/3861

(57) ABSTRACT

Technical solutions are directed to systems and methods in which a band coupled with a body of a device includes an antenna operably coupled with the body, and a set of sensors supported by at least one of the body and the band. The set of sensors can generate measurements indicative of interaction between a portion of a body of a user and the at least one of the body and the band. A controller coupled with the set of sensors can identify, based on the measurements, a distribution of load induced by the portion of the body of the user, corresponding to the interaction, determine, based on the distribution of load, a return loss characteristic of the antenna associated with the portion of the body of the user, and adjust a frequency response of the antenna according to the return loss characteristic.

### CROSS REFERENCE TO RELATED APPLICATIONS

This application is a Continuation-in-Part of, and claims the benefit of priority under 35 U.S.C. § 120 to U.S. patent application Ser. No. 18/980,979, filed Dec. 13, 2024, entitled “Apparatuses, Systems, and Methods for Sensor Detection” which claims the benefit of priority under 35 U.S.C. § 119(e) to U.S. Provisional Ser. No. 63/701,786 , filed Oct. 1, 2024, entitled “Sensor Based Antenna Tuning For Test Phantoms and Human Wrists,” each of which is hereby incorporated by reference herein in its entirety and for all purposes.

### BACKGROUND

Wearable devices can provide users with convenient access to computing resources, communications, and health monitoring functions while being worn on the body. These devices often rely on wireless communication systems that operate across multiple frequency bands. However, maintaining reliable wireless performance in wearable devices can be challenging due to varying user conditions and environmental factors.

### SUMMARY

Wearable devices that include antennas integrated within a device body or a surrounding band can experience detuning when placed in proximity to different human body conditions. Variations in wrist geometry, tissue composition, and band tightness, or other user interaction can introduce loading effects that may shift the antenna return loss curve, adversely affecting transmission efficiency or increasing reflected energy within the device circuitry. Traditional antenna designs that are calibrated against standardized test phantoms can fail to account for user-specific differences, as the dielectric response of a rigid phantom may not replicate dynamic variations observed on real user wrists. As a result, antennas tuned against fixed models can experience frequency offsets of over one hundred megahertz during real-world use, producing variable performance across wireless communication bands such as cellular, Bluetooth, and satellite navigation.

The technical solutions of the present application can use sensors distributed along the device body and band to generate measurements indicative of applied force, strain, or tension caused by a user wrist, and configure or adjust the wearable device antenna performance according to the characteristics of the user. The solutions can provide a controller that can be operably coupled with the sensors to classify the measurements into loading profiles that correspond to specific wearing conditions, such as tight fit, loose fit, or partial loading. The controller can determine a return loss characteristic of the antenna based on the detected loading profile and can select an antenna tuning configuration from stored associations maintained in memory. The tuning configuration can include adjustment of an impedance matching network formed of capacitors and inductors, such that a minimum value of the return loss curve is aligned with a desired operating frequency. The controller can switch between multiple antennas, for example by activating an antenna on one side of a device body when another antenna is subject to high absorption, such that optimal frequency performance is maintained across communication bands while the wearable device shifts position on the wrist.

At least one aspect relates to a system. The system can include a band coupled with a body of a device. The system can include an antenna operably coupled with the body. The system can include a set of sensors supported by at least one of the body and the band, the set of sensors configured to generate measurements indicative of interaction between a portion of a body of a user and the at least one of the body and the band. The system can include a controller operably coupled with the set of sensors. The system can identify, based on the measurements, a distribution of load induced by the portion of the body of the user, corresponding to the interaction. The system can determine, based on the distribution of load, a return loss characteristic of the antenna associated with the portion of the body of the user. The system can adjust a frequency response of the antenna according to the return loss characteristic.

The system can further comprise a tuner operably coupled with the antenna. The tuner can include an impedance matching network comprising a plurality of components to adjust the frequency response of the antenna to match a frequency response associated with the return loss characteristic. The controller can select, from a plurality of configurations for the plurality of components, a configuration corresponding to the return loss characteristic. The controller can cause the configuration to be applied to one or more components of the plurality of components of the impedance matching network to adjust the frequency response of the antenna according to the frequency response associated with the return loss characteristic.

The set of sensors can be supported by the body and by the band and comprises at least one force sensor positioned to measure a force applied by the portion of the body of the user to at least one of the body and the band. The set of sensors can include at least one strain sensor coupled to the device body and configured to measure strain indicative of mechanical load caused by the portion of the body of the user. The set of sensors can include at least one tension sensor configured to measure a tension of the band when the wearable device is worn by the portion of the body of the user. The controller can identify the distribution of load by classifying the measurements into a loading profile, the loading profile identifying a first measurement of a first sensor of the set of sensors that is greater than a second measurement of a second sensor of the set of sensors, the first sensor supported by the body and the second sensor supported by the band.

The controller can map the distribution of load to a configuration of a plurality of configurations specifying a plurality of frequency responses of the antenna for a plurality of return loss characteristics. The configuration can correspond to one or more settings of one or more components of an impedance matching network to achieve a setting for a frequency response corresponding to the return loss characteristic. The return loss characteristic can correspond to a frequency distribution of energy loss caused by the portion of the body of the user to the antenna. In some implementations, the configuration defines the one or more settings of components of the impedance matching network that include at least two of a capacitor, an inductor, and a resistor.

The return loss characteristic can include a return loss curve of the antenna as a function of frequency, and the controller is configured to adjust the frequency response of the antenna by positioning a minimum value of the return loss curve within a predetermined operating band. The predetermined operating band can correspond to a wireless communication band of at least cellular communication bands, Bluetooth communication bands, Wi-Fi communication bands, or GNSS bands, and the controller is configured to select an adjustment to the frequency response based on the predetermined operating band. The system may further comprise a second antenna, wherein the controller is configured to, responsive to the distribution of load, select between the antenna and the second antenna to reduce absorption by the portion of the body of the user corresponding to the return loss characteristic. The controller can be configured to determine the return loss characteristic by retrieving, from a memory, a stored association between the measurements and respective antenna return loss characteristics. The controller can be configured to update the stored association based on measurements acquired while a wearable device comprising the body and the band is worn by the user.

At least one other aspect relates to a method. The method can be performed, for example, by one or more processors coupled to non-transitory memory. The method can include coupling a band with a body of a device that is coupled with an antenna with the body. The method can include generating, by a set of sensors supported by at least one of the body and the band, measurements indicative of interaction between a portion of a body of a user and the at least one of the body and the band. The method can include identifying, based on the measurements, a distribution of load induced by the portion of the body of the user, corresponding to the interaction. The method can include determining, based on the distribution of load, a return loss characteristic of the antenna associated with the portion of the body of the user. The method can include adjusting a frequency response of the antenna according to the return loss characteristic.

The method can further include providing an impedance matching network of a tuner operatively coupled with the antenna, the impedance matching network comprising a plurality of components. The method can further include adjusting, via the impedance matching network of the tuner, the frequency response of the antenna to match a frequency response associated with the return loss characteristic. The method can further include selecting, from a plurality of configurations for the plurality of components, a configuration corresponding to the return loss characteristic. The method can include applying the configuration to one or more components of the plurality of components of the impedance matching network to adjust the frequency response of the antenna according to the frequency response associated with the return loss characteristic. The set of sensors is supported by the body and by the band and comprises at least one force sensor positioned to measure a force applied by the portion of the body of the user to at least one of the body and the band.

At least one aspect relates to a non-transitory computer-readable medium. The medium can store instructions, which when executed by one or more processors, cause the one or more processors to receive, from a set of sensors supported by at least one of a body of a device coupled with a band that is operably coupled with an antenna, measurements that are indicative of interaction between a portion of a body of a user and the at least one of the body and the band. The medium can store instructions, which when executed, cause the one or more processors to identify, based on the measurements, a distribution of load induced by the portion of the body of the user, corresponding to the interaction. The medium can store instructions, which when executed, cause the one or more processors to determine, based on the distribution of load, a return loss characteristic of the antenna associated with the portion of the body of the user. The medium can store instructions, which when executed, cause the one or more processors to adjust a frequency response of the antenna according to the return loss characteristic.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a cutaway schematic diagram of a concealed optical sensor behind a surface shell.

FIG. 2 is a closeup diagram of a portion of a head mounted display that incorporates a concealed optical sensor.

FIG. 3 is a schematic diagram of a head mounted display that incorporates a concealed optical sensor.

FIG. 4 is an additional schematic diagram of a head mounted display that incorporates a concealed optical sensor and illustrates a field of view of the concealed optical sensor.

FIG. 5 is an illustration of an exemplary operating circuit for battery protection, according to some embodiments.

FIG. 6 is an illustration of an exemplary block diagram for in-situ battery swell detection and adaptive antenna tuning, according to certain embodiments.

FIG. 7 is an illustration of exemplary flowcharts for in-situ battery swell detection and adaptive antenna tuning, according to some embodiments.

FIG. 8 is an illustration of an exemplary graph of scattering parameters for a human wrist and a test phantom, according to some embodiments.

FIG. 9 is an illustration of an exemplary antenna tune code and antenna tuning circuit, according to certain embodiments.

FIGS. 10A and 10B is an illustration of exemplary force sensors and band sensors on a smartwatch, according to particular embodiments.

FIGS. 11A and 11B is an illustration of an exemplary test phantom and human wrist donning a smartwatch with force and band sensors, according to some embodiments.

FIGS. 12A and 12B is an illustration of exemplary human wrists donning a smartwatch with multiple antennas, according to certain embodiments.

FIGS. 12C and 12D are illustrations of an exemplary human-machine interface configured to be worn around a user's lower arm or wrist.

FIGS. 12E and 12F are illustrations of an exemplary schematic diagram with internal components of a wearable system.

FIG. 13 is an illustration of an exemplary fluidic control system that may be used in connection with embodiments of this disclosure.

FIG. 14 is a plan view of a microvalve array, taken from line A-A of FIG. 3, according to at least one embodiment of the present disclosure.

FIG. 15 is a side cross-sectional view of a microvalve of the microvalve array of FIG. 14, taken from line B-B of FIG. 14, according to at least one embodiment of the present disclosure.

FIG. 16 is a flow diagram illustrating a method of forming a microvalve array, according to at least one embodiment of the present disclosure.

FIG. 17A is front view of an example haptic feedback device according to embodiments of this disclosure.

FIG. 17B is a back view of the example haptic feedback device shown in FIG. FIG. 17A according to embodiments of this disclosure.

FIG. 18 is a block diagram of example components of a haptic feedback device according to embodiments of this disclosure.

FIG. 19 is an illustration of an example artificial-reality system according to some embodiments of this disclosure.

FIG. 20 is an illustration of an example artificial-reality system with a handheld device according to some embodiments of this disclosure.

FIG. 21A is an illustration of example user interactions within an artificial-reality system according to some embodiments of this disclosure.

FIG. 21B is an illustration of example user interactions within an artificial-reality system according to some embodiments of this disclosure.

FIG. 22A is an illustration of example user interactions within an artificial-reality system according to some embodiments of this disclosure.

FIG. 22B is an illustration of example user interactions within an artificial-reality system according to some embodiments of this disclosure.

FIG. 23 is an illustration of an example wrist-wearable device of an artificial-reality system according to some embodiments of this disclosure.

FIG. 24 is an illustration of an example wearable artificial-reality system according to some embodiments of this disclosure.

FIG. 25 is an illustration of an example augmented-reality system according to some embodiments of this disclosure.

FIG. 26A is an illustration of an example virtual-reality system according to some embodiments of this disclosure.

FIG. 26B is an illustration of another perspective of the virtual-reality systems shown in FIG. 26A.

FIG. 27 is a block diagram showing system components of example artificial-and virtual-reality systems.

FIG. 28 is a block diagram for adjusting antenna performance in wearable devices based on detected load distribution.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to apparatuses, systems, and methods for sensor detection. As will be explained in greater detail below, the apparatuses and systems described herein may incorporate optical sensors concealed in or behind the external housing of a device, thereby enabling the device to detect ambient light conditions while minimizing aesthetic disruptions to the exterior surface of the device. The improved aesthetics that result from using hidden optical sensors versus optical sensors behind a more traditional optically transparent window or panel may lead to improved customer satisfaction.

Ambient light sensors and/or flicker sensors are often needed on an electronic device to help detect ambient light, ambient color, and ambient flicker to help the cameras/display of a device to better adapt image quality. The flicker sensor is particularly important for virtual reality devices that enables mixed reality passthrough region to help the video stream mitigate banding artifacts. However, enabling a flicker/light sensor on a device often comes with cosmetic sacrifices. Many conventional designs employ a dark or semitransparent window where the sensor is hidden behind. This dark window can often be seen as a dark window on the front/back of smartphones near its cameras. These windows often lead to cosmetic discontinuities that can reduce overall customer satisfaction with a product.

The apparatuses and systems described herein, on the other hand, can situate an ambient light or flicker sensor behind a section of the device housing that is thinned out and processed to allow a certain amount of light to pass through (such as 1% to 30% of incident light, or an average of 12% of light striking the surface of the device) while appearing opaque and contiguous with the rest of the housing to an external observer. These devices can also include optically transparent filler or bracing to prevent the thinned out section of the housing from presenting a structural weak point. Furthermore, the sensor itself can be placed on a substrate (such as flexible printed circuit substrates) with a color that is similar to the housing to further conceal the optical sensor, the housing can be textured to improve light scattering (and therefore concealment of the sensor), and/or surfaces of the housing can be shaped to act as light guides to direct the field of view of the concealed optical sensor.

One of the most challenging aspects of employing lithium-ion battery technology in consumer devices is the battery's sensitivity to higher operating temperatures, which may accelerate degradation processes. For example, these degradation processes may generate byproduct gases that accumulate within the hermetically sealed battery cell, causing the battery cell's soft pouch to swell. Given the limited space between the battery enclosure and the system's other internal components, it becomes increasingly important to prevent the degradation processes as the battery enclosure may become mechanically compromised. While preemptive methods to predict swelling of the battery may be employed through modeling, the time to build, tune, and verify each model of battery may become expensive across a large population of batteries. Comparatively, reactive approaches (e.g. generally contact-based sensors) may be space intensive due to the amount of volume an extra design component consumes, lessening energy density.

Wearable devices (e.g., a wristband system) may be configured to be worn on a user's body part, such as a user's wrist, arm, leg, torso, neck, head, finger, etc. Such wearable devices may be configured to perform various functions. For example, a wristband system may be an electronic device worn on a user's wrist that performs functions such as delivering content to the user, executing social media applications, executing artificial-reality applications, messaging, web browsing, sensing ambient conditions, interfacing with head-mounted displays, monitoring a health status of the user, etc. Many of the functions of the wearable device may require wireless communications to exchange data with other devices, servers, etc. However, since wearable devices are typically worn on a body part (e.g., a wrist, an ankle, etc.) of a user, the body part of the user may negatively affect the performance of the wireless communications by absorbing or altering wireless signals.

Microfluidic mechanisms are fluidic mechanisms that include very small components, such as valves and fluid channels. Microfluidic mechanisms can be used in a verity of fields, such as in medicine and fluidic haptics. Microvalves may operate by opening and closing fluid channels. Since the microvalves operate at a very small scale (e.g., on the order of millimeters or microns), some feedback mechanisms can be used to determine whether and how the microvalves function. For example, pressure sensors may be used to determine if fluid (e.g., gas) is flowing through, or stopped from flowing through, a microvalve. Pressure sensing can be accomplished with a separate pressure sensor chip adjacent to a microvalve array chip. This separate pressure sensor chip can add to the complexity and cost of a microfluidic mechanism.

The present disclosure is generally directed to integrated pressure sensors for microvalves. An array of microvalves may be formed in a silicon substrate, including a fluid channel and a valve (e.g., a cantilevered valve plug) to open and close the fluid channel. The microvalve array may include four distinct piezoelectric (e.g., polysilicon) materials surrounding each fluid channel. These piezoelectric portions will experience changes in mechanical stress, and therefore electrical resistance, upon changes in pressure within the fluid channel. The four portions may be connected to electrical circuitry (e.g., integrated in the silicon substrate) to form a Wheatstone bridge for measuring the electrical resistance and, therefore, pressure within the fluid channel.

This pressure sensor can be used to provide feedback for each microvalve in the array of microvalves, which can be helpful to confirm when the microvalves are open or closed and to determine the appropriate amount of electrical energy needed to open and close the valves with respective valves (e.g., cantilevered valve plugs). The microvalves can be used in many fluidic systems, including with haptic gloves to selectively fill an array of bladders in the gloves. The integrated pressure sensor will cut down on the space and expense that would otherwise be required with a separate pressure sensor chip.

The present disclosure is generally directed to apparatuses, systems, and methods for concealed optical sensors. As will be explained in greater detail below, the apparatuses and systems described herein may incorporate optical sensors concealed in or behind the external housing of a device, thereby enabling the device to detect ambient light conditions while minimizing aesthetic disruptions to the exterior surface of the device. The improved aesthetics that result from using hidden optical sensors versus optical sensors behind a more traditional optically transparent window or panel may lead to improved customer satisfaction. In some examples, the present disclosure is generally directed to systems and methods for actively discharging a smart glasses case when certain temperature thresholds are met to avoid thermal damage. The idea uses a combination of hardware and firmware to detect when the case is at or approaching high temperatures using a battery temperature sensor and then algorithmically determine when it should start to actively discharge. An active discharge circuit can be implemented using several metal-oxide-semiconductor field-effect transistors (MOSFETs) with general-purpose input/output (GPIO) control, each connected to a high-power resistor. These MOSFETs can be turned on independently to control how much current is being discharged. The total current can be up to hundreds of mA. Splitting up the circuit into multiple parallel resistors also spreads out the heat dissipation in the case to avoid a specific hotspot that could damage components or the user. In some examples, the present disclosure is directed to systems and methods for in-situ battery swell detection and adaptive antenna tuning using a radio frequency (RF) coupler to monitor antenna performance. As a battery enclosure swells, an internal air gap between the battery cell and other internal components in the system may be decreased, causing a change in antenna impedance and consequently a higher amount of reflected power back to an RF power amplifier. A mathematical relationship between the reflected power and the battery swelling level may be established such that the system derives an approximate positional increase in the thickness displacement of the battery. In this manner, as the microprocessor receives a readable output signal from the RF coupler, indicating a change in thickness displacement, a battery charging voltage level may be decreased, and the overall lifetime battery swelling may be decreased. For example, the rate of future swelling may decrease each time the battery is in use, such that the total swelling decreases over the battery's life. In some examples, the present disclosure is generally directed to sensor-based antenna turning for a test phantom and human wrist of a mobile electronic device (e.g., wearable device, a smartwatch, a wristband system, etc.). As will be explained in greater detail below, embodiments of the present disclosure may include a set of sensors placed on a human wrist band and/or test phantom to detect force, strain, and band tightness for antenna tuning. In this manner, antenna tune codes may be optimized based on the detected values from the sensors. For example, a set of three sensors may be placed inside a watch body of a human wrist band and/or test phantom to detect force and strain values. Additionally, multiple sensors may be placed around the band to detect the tightness of the band. Furthermore, tune code for a partial loading condition may be applied to the antenna if the detected force on one sensor is greater than the other sensor. In this manner, sensor information may account for the varying donning conditions of a user by tuning the antennas and/or switching between multiple antennas. In some examples, the present disclosure may include haptic fluidic systems that involve the control (e.g., stopping, starting, restricting, increasing, etc.) of fluid flow through a fluid channel. The control of fluid flow may be accomplished with a fluidic valve. Fluid from a fluid source (e.g., a pressurized fluid source, a fluid pump, etc.) may flow through the fluid channel from an inlet port to an outlet port, which may be operably coupled to, for example, a fluid-driven mechanism, another fluid channel, or a fluid reservoir.

Features from any of the embodiments described herein may be used in combination with one another in accordance with the general principles described herein. These and other embodiments, features, and advantages will be more fully understood upon reading the following detailed description in conjunction with the accompanying drawings and claims.

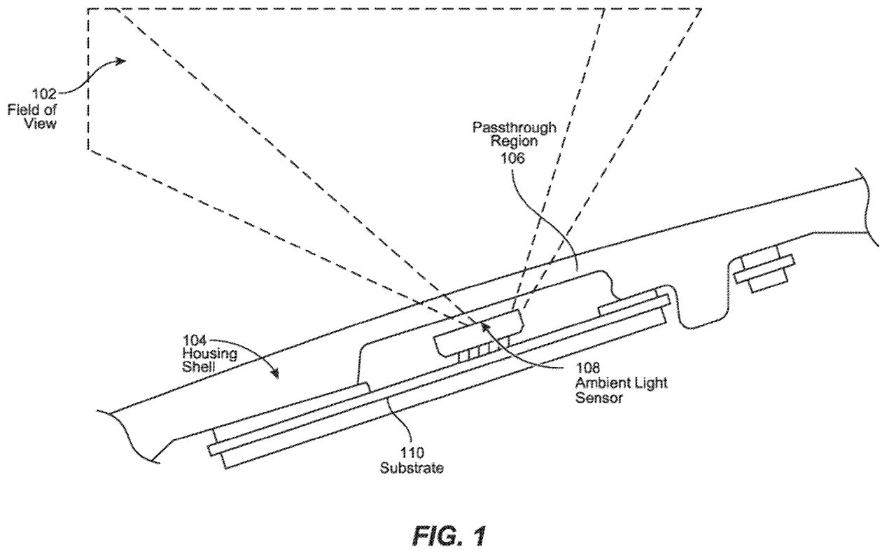

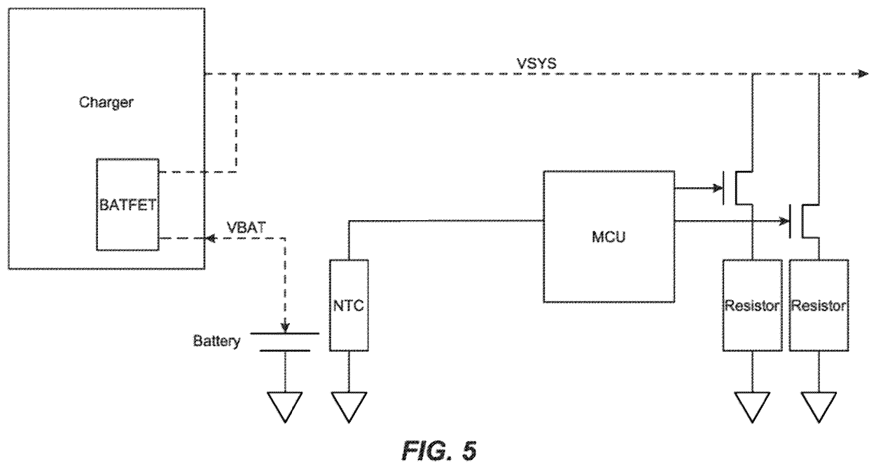

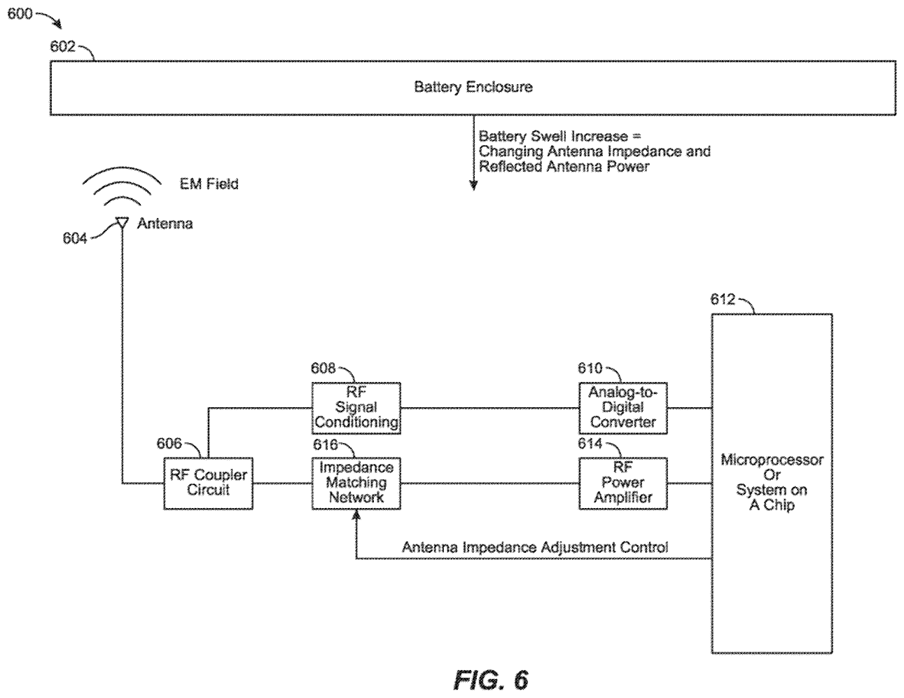

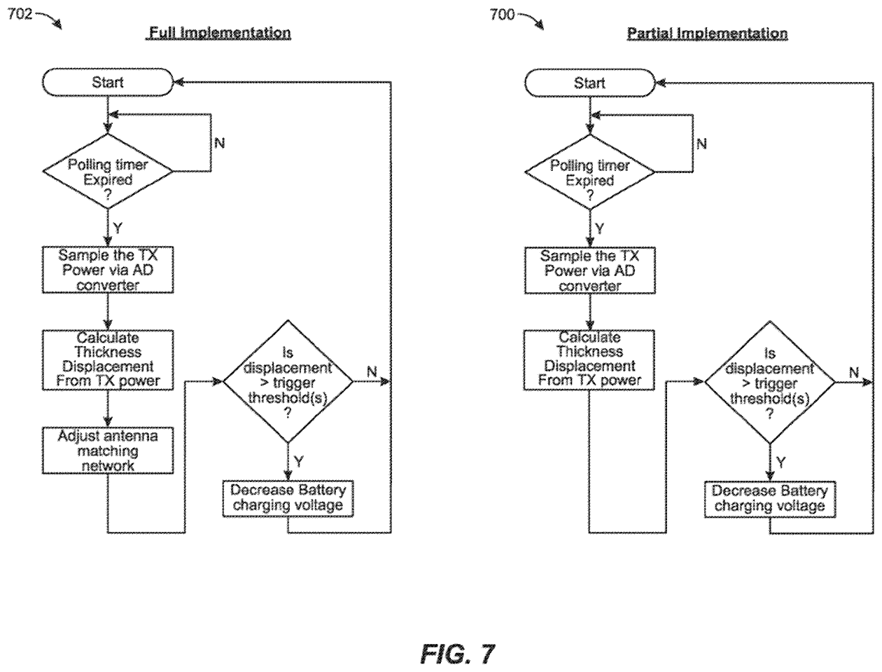

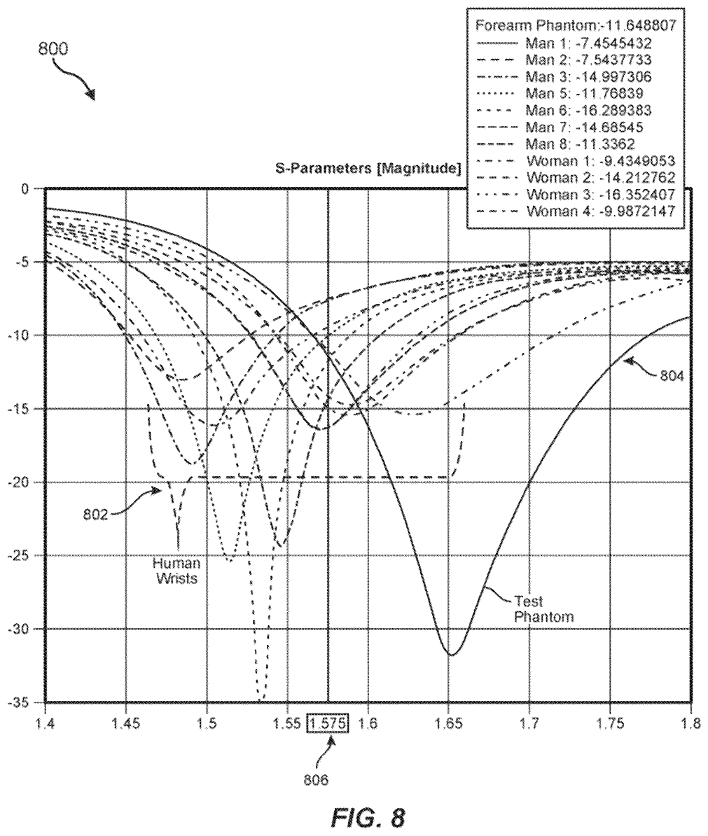

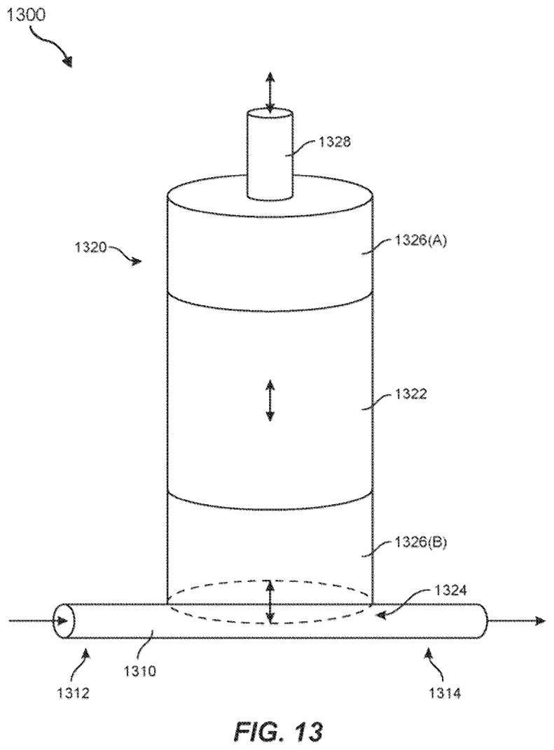

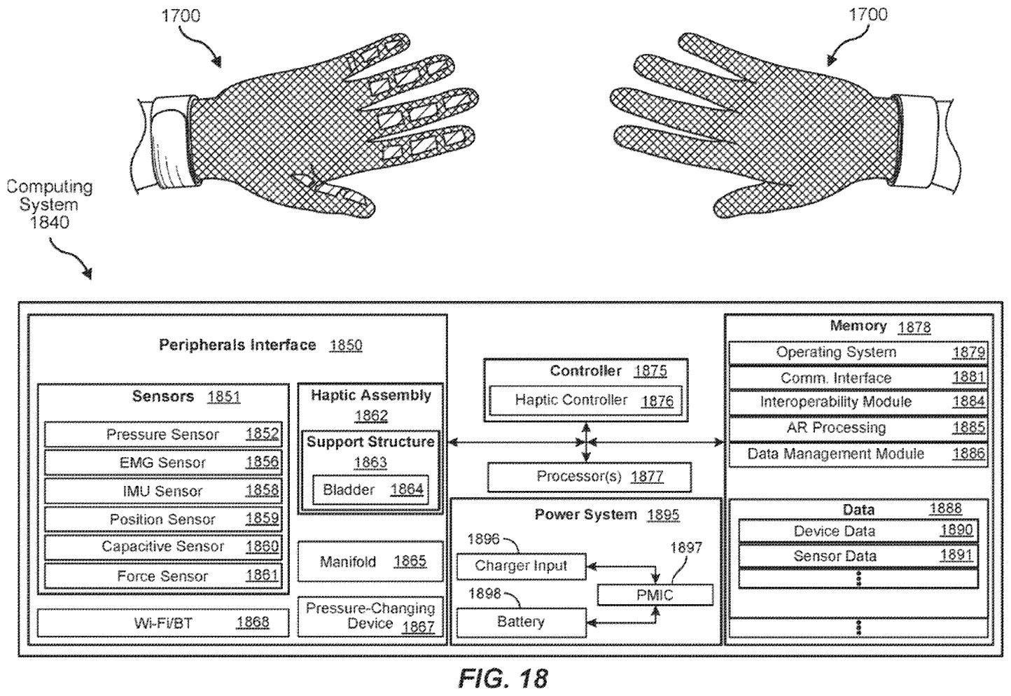

The following will provide, with reference to FIGS. 1-4, detailed descriptions of concealed optical sensors. The following will provide, with reference to FIG. 5, detailed descriptions for improved heat discharge. The following will provide, with reference to FIGS. 6-7, detailed descriptions for in-situ battery swell detection and adaptive antenna tuning. The following will provide, with reference to FIGS. 8-12B, detailed descriptions for sensor based antenna tunning for a test phantom and human wrist. The following will provide, with reference to FIGS. 13-17B, detailed descriptions of example apparatuses and systems that include microvalves with integrated pressure sensors. Detailed descriptions of example augmented reality devices will be discussed with reference to FIGS. 18-26.

FIG. 1 is a cutaway schematic diagram of an apparatus that incorporates a concealed optical sensor. In the example of FIG. 1, an ambient light sensor 108 is positioned atop a substrate 110 that holds ambient light sensor 108 in position behind passthrough region 106 of housing shell 104. As shown in the diagram, passthrough region 106 is a thinned out region of housing shell 104, thereby increasing the optical transparency of passthrough region 106 relative to other regions of housing shell 104. The position of ambient light sensor 108 affords ambient light sensor 108 a field of view 102 of its surroundings, which can be altered or tuned by shaping passthrough region 106 to act as a light guide for ambient light sensor 108.

Housing shell 104 can be formed from a variety of materials in a variety of ways. For example, housing shell 104 can be formed from plastic, glass, metal, or any other material suitable for serving as an outer shell for an apparatus. In some examples, housing shell 104 can be colored, dyed, infused with nanoparticles, or otherwise given reflective, refractive, and/or other optical properties that improve the exterior aesthetics of housing shell 104. As shown in the example of FIG. 1, the exterior surface of housing shell 104 can be smooth and uninterrupted by unsightly seams or other aesthetic disruptions, while the interior structure of passthrough region 106 can allow a certain amount of light to reach ambient light sensor 108 that is situated behind passthrough region 106. In some examples, passthrough region 106 can be configured to allow anywhere from 1% to 30% of light striking the outer surface of housing shell 104 to pass through to ambient light sensor 108. In some embodiments, passthrough region 106 can be configured to allow an average of 12% of light striking the outer surface of housing shell 104 to pass through to ambient light sensor 108.

In some examples, either an inner or outer surface of housing shell 104 can be textured to improve light scattering of light striking or passing through housing shell 104. In some embodiments, this texturing can be limited to passthrough region 106. In other embodiments, the entire surface of housing shell 104 can be textured. This improvement in light scattering can help blur the edges of passthrough region 106, thereby reducing the visibility of passthrough region 106 to users or other individuals viewing the exterior surface of housing shell 104.

Ambient light sensor 108 can be configured in a variety of ways. As mentioned above, ambient light sensor 108 can be a sensor configured to detect an overall level of ambient light and/or flicker present in ambient lighting conditions. Ambient light sensor 108 can also be configured to detect a variety of wavelengths of light, such as visual light or infrared light, and provide a signal to a control module that can control and/or configure other elements of the apparatus such as cameras.

Substrate 110 generally represents any sort of physical structure that supports ambient light sensor 108. In some embodiments, substrate 110 can be formed from flexible printed circuit board (flexible PCB), though any suitable material or combination of materials can be used. In some embodiments, substrate 110 can be colored, tinted, or otherwise granted optical properties to enhance the camouflage of ambient light sensor 108 behind passthrough region 106. For example, substrate 110 can be colored to have substantially the same or similar color as housing shell 104. As a specific example, if housing shell 104 is white, substrate 110 can likewise be colored white to ensure that light striking substrate 110 and reflecting back out through passthrough region 106 preserves the illusion that housing shell 104 is undisturbed by the presence of any optical sensors concealed behind passthrough region 106.

In some embodiments, the space between substrate 110 and housing shell 104 can be partially or wholly occupied by an optically transparent filler material, such as a clear plastic or glass, to act as a shell brace and prevent passthrough region 106 from becoming a structural weak point in housing shell 104. By filling the void behind housing shell 104 formed by passthrough region 106, the filler material or housing shell brace can help preserve the structural integrity of housing shell 104. In some embodiments, the shell brace can be coupled directly to the underside of passthrough region 106. In one example, the shell brace can bring the total thickness of passthrough region 106 (i.e., the combined thickness of the optically transparent shell brace plus the thickness of the passthrough portion of housing shell 104) to the same thickness as the adjoining full-thickness regions of housing shell 104.

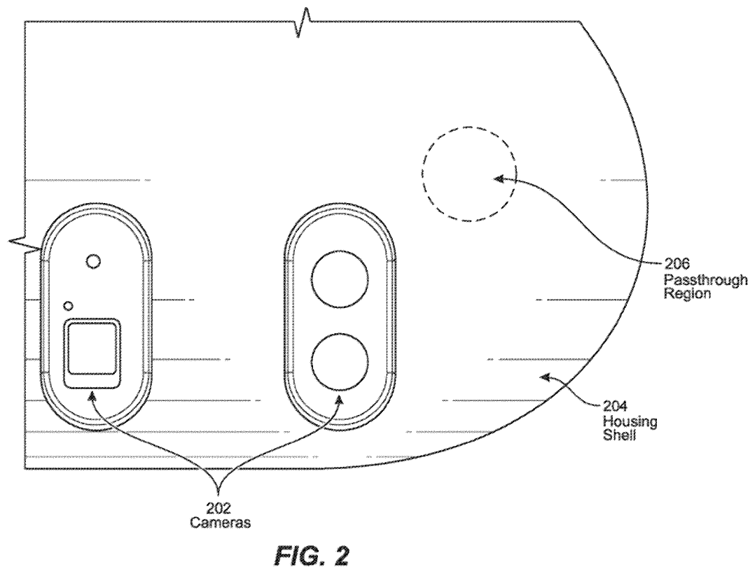

FIG. 2 is a closeup of a region of an example system that incorporates a concealed optical sensor. In the example of FIG. 2, the system includes a pair of cameras 202 that are configured to record visual information about their surroundings and provide a camera signal to the system. Cameras 202 are mounted in or on housing shell 204 that serves as the exterior physical shell of the system. As described above, housing shell 204 can include a passthrough region 206, which conceals an ambient light sensor (not illustrated, as it is occluded by the outer surface of housing shell 204/passthrough region 206). As described above, passthrough region 206 can be formed into housing shell 204 such that the exterior surface of housing shell 204 is not disrupted by seams, breaks, joins, windows, or other aesthetic disruptions.

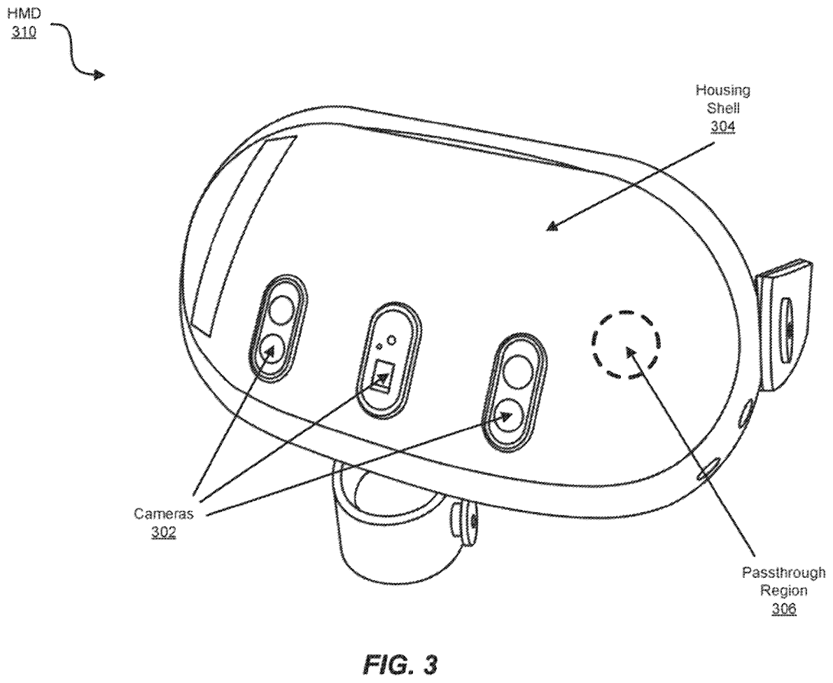

In some embodiments, the system represented by FIG. 2 can be a portion of a head mounted display (HMD). FIG. 3 is an illustration of an example HMD 310 that incorporates three cameras 302. Cameras 302 are configured to provide camera signals to a control processor of HMD 310. HMD 310 also includes a housing shell 304 that covers, protects, and/or provides structural support for various components of HMD 310. As described above, housing shell 304 can include a passthrough region 306 that is configured to allow enough light to reach an ambient light sensor or other optical sensor positioned behind passthrough region 306. The optical sensor positioned behind passthrough region 306 can provide ambient light, flicker, and/or other lighting condition information to a control unit of HMD 310 to enable HMD 310 to properly configure cameras 302 to record their environment.

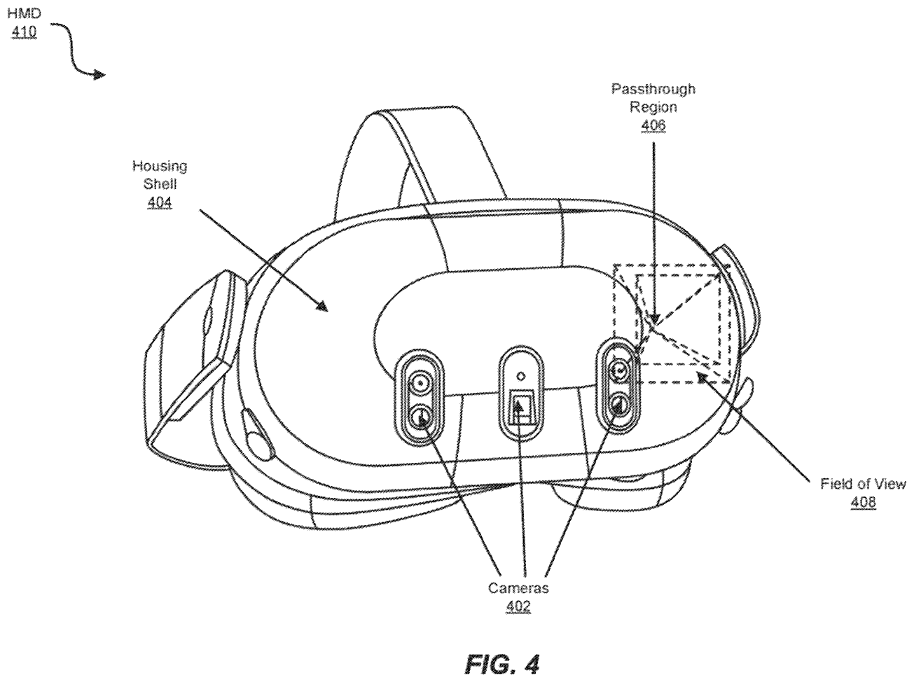

FIG. 4 is an illustration of an additional HMD (illustrated as HMD 410). As with other devices illustrated and described herein, HMD 410 includes a housing shell 404 that provides protection and/or structural support to other components of HMD 410, including cameras 402. HMD 410 also includes a passthrough region 406, which as described in greater detail above, is configured to allow a certain amount (e.g., an average of 12%) of light to pass through passthrough region 406 to be detected by an optical sensor mounted behind passthrough region 406. The configuration of passthrough region 406 affords the optical sensor (not illustrated in FIG. 4 by virtue of being occluded by housing shell 404) a field of view 408 of its surroundings. Field of view 408 can be tuned to be aligned with fields of view of all or a subset of cameras 402 to ensure that the ambient light sensor is able to provide useful lighting information to the control unit of HMD 410.

As described above, various devices such as AR/VR head mounted displays, mobile phones, and other devices can incorporate a passthrough region into the outer housing of the device and conceal a secondary optical sensor such as an ambient light sensor behind the passthrough region. By concealing the ambient light sensor in this way, manufacturers of devices that use concealed optical sensors can reduce the number of visual interruptions in the outer housing of the device, thereby improving the overall aesthetics of the device while retaining necessary functionality to properly configure other components of the device such as cameras.

FIG. 5 illustrates an operating circuit with a microcontroller that may sense a temperature value of a battery circuit using a thermal sensor (e.g., negative temperature coefficient thermistor (NTC)). The thermal sensor may be built into a battery pack within the battery circuit. In some methods, the microcontroller may activate a heat dissipation element within the battery circuit when the temperature value reaches a predetermined threshold. The microcontroller may connect to an active discharge circuit including heat dissipation elements, which may include but are not limited to high-power resistors, GPIO control units, and MOSFETS. The microcontroller may have independent control over each high-power resistor via a GPIO control over a MOSFET. The MOSFETS may be turned on independently to control the amount of current that may be discharged from the battery. The active discharge circuit may be split up into multiple parallel resistors that may spread out the heat dissipation and avoid hot spots that may damage surrounding components within the battery circuit. In other methods, the microcontroller may discharge heat from the battery circuit via the activated heat dissipation elements. The microcontroller may predict via firmware (e.g., algorithm, prediction model, etc.) when it is optimal to discharge heat from the battery depending on a variety of conditions, including when the temperature value reaches the predetermined threshold and when the battery reaches a safe level of voltage. In further embodiments, the microcontroller may deactivate the heat dissipation element when the temperature value falls below the predetermined threshold.

In some embodiments, the battery circuit may have various configurations and/or components. In some examples, the active discharge circuit and additional components (including, e.g., an integrated circuit) may be spatially positioned away from the battery or to minimize risk of thermal damage to key components and the battery.

Referring to FIG. 6, system 600 illustrates a block diagram for detecting the swell of a battery 602. System 600 may include an RF coupler 606 that is configured to generate and send an output signal via an analog to digital converter 610 to a microprocessor 612. RF coupler 606 may be placed in a transmit path of an antenna 604 to sample the amount of reflected power back to an RF power amplifier 614 and understand the performance of antenna 604. For example, the output signal may be received by RF signal conditioning circuitry 608 (i.e., RF envelop detector), such that RF signal conditioning circuitry 608 may convert the output signal for digital processing by an analog to digital converter 610. Consequently, analog to digital converter 610 may then convert the output signal into a readable format for the microprocessor 612.

In some embodiments, if the converted output signal indicates a higher amount of reflected power back to the RF power amplifier 614, microprocessor 612 may detect a positional increase in a thickness displacement of battery 602. For example, as the swell of battery 602 increases, an internal air gap between the battery 602 and other internal components in the system (i.e., RF signal conditioning circuitry 608, microprocessor 612, etc.) may decrease and change an impedance of the antenna 604, translating to a higher amount of reflected power. An established mathematical relationship between the reflected power and the battery swelling level may allow microprocessor 612 to derive the approximate positional increase in the thickness displacement of the battery 602.

Furthermore, this relationship may represent a displacement of the thickness of the battery 602 from its origin, instead of an absolute positional increase that may vary due to inherent differences in initial battery thicknesses resulting from manufacturing variations. In this manner, a swelling response threshold may be established and the maximum charging voltage of the battery 602 may be accordingly adjusted from the received output signals. In some embodiments, a series of thresholds may be established with progressively decreasing charging voltage levels, such that the system may adjust more gradually. In some embodiments, an impedance matching network 616 (i.e., antenna tuner) may be adjusted to reoptimize the impedance of the antenna 604, based on a detected change in the thickness displacement of the battery 602, in tandem with operating environment changes.

FIG. 7 illustrates a partial implementation flowchart 700 and a full implementation flowchart 702 for in-situ battery swell detection and adaptive antenna tuning. Partial implementation flowchart 700 may illustrate a series of steps for detecting battery swelling, where a battery charging voltage is decreased due to a thickness displacement of a battery. As mentioned earlier, an RF coupler may sample the amount of reflected power in the form of an output signal and send the output signal to an analog to digital converter for digital processing. In some embodiments, a thickness displacement detailing the approximate positional increase of the battery may be calculated and evaluated to determine if a swelling response threshold is triggered. In further embodiments, if the swelling response threshold is triggered, the battery charging voltage is decreased, and if the swelling response threshold is not triggered, partial implementation flowchart 700 restarts.

In some embodiments, adaptive antenna tuning may be included as part of the system, as illustrated in the full implementation flowchart 702. Similarly to partial implementation flowchart 700, the steps may be identical in full implementation flowchart 702 besides the adjusting of an antenna matching network. In this full implementation flowchart 702, an adjustable version of the antenna impedance matching network may allow the system to compensate the impedance for the reflected power. In this manner, the antenna and overall wireless connectivity performance may be preserved, despite the internal battery swelling status.

In some embodiments, the presence of the RF coupler may remove any need for contact-based battery swelling sensors, saving the system valuable cost and space. Furthermore, because the system may not rely on a conductive material or a sensor to work, there is no confinement on specific materials for a battery's enclosure. In further embodiments, there may be no need to rely on a static, offline-generated model to determine a battery's swelling level, but rather a relative change in thickness that is derived in-situ.

Wearable electronic devices can integrate multiple wireless communication systems into increasingly compact form factors. As these devices evolve to support broader functionality (e.g., continuous health tracking, contactless payments, and location-based services), their antennas of these wearable devices are designed to operate across diverse frequency bands while coexisting in close proximity to conductive components, metallic housings, and the variable dielectric properties of the human body. These constraints can complicate the maintenance of stable antenna performance in dynamic, everyday environments. User interactions, such as tightness or looseness of the wearable device on the user's wrist, as well as environmental changes such as varying skin hydration, temperature fluctuations, and different device orientations during motion can introduce unpredictable impedance shifts. Without active or responsive adaptation, such changes may degrade link quality, increase power consumption, or cause intermittent loss of connectivity.

The technical solutions of this application, such as those described in connection with FIGS. 8-12F, illustrate wearable devices that can detect and adapt to variations in antenna loading caused by user-specific wearing conditions. In these examples, the device can incorporate sensing elements capable of determining localized changes in fit or pressure around the band or housing, allowing for real-time awareness of the mechanical and electromagnetic coupling and interactions between the device and the wearer. Based on the detected conditions, control circuitry can dynamically adjust antenna tuning, select among multiple antennas, or reconfigure matching networks to maintain optimal signal transmission and reception. By aligning antenna performance to the prevailing loading environment, these embodiments can enhance wireless efficiency and reliability across a range of operational contexts, including movement, changes in wrist geometry, and differences between individual wearers.

Referring to FIG. 8, graph 800 illustrates plots of the various scattering parameters for human wrists 802. The scattering perimeter plots can correspond to, or be indicative of antenna energy losses or reflected energy losses plotted on frequency x-axis. For instance, the plots can differ or be based on the donning conditions for different users, and scattering parameters for a test phantom 804. For instance, “scattering parameters,” or “s-parameters,” may generally refer to an electrical behavior of linear electrical networks when undergoing various steady state stimuli by electrical signals. Graph 800 may illustrate a performance of an antenna at different frequencies, as illustrated in FIG. 8. Furthermore, graph 800 may illustrate a desired operating frequency 806, in which an antenna may need to be tuned for, based on the various donning conditions of human wrists 802 and test phantom 804.

The scattering parameters illustrated in FIG. 8 can be generated during calibration in both phantom and real-wrist scenarios. The phantom may be a cellular telecommunications and internet association (CTIA) specified arm-shaped fixture which can be made using rubberized material with fixed dielectric properties and used for compliance testing. However, as phantom's dielectric loading can differ from properties of various human users in terms of frequency response, the antenna's return-loss curve (S11) when measured on the phantom can be offset from the one that may be observed on actual human wrists. In some instances, the shift in terms of frequency can be by 100 MHz or more, which may lead to significant detuning and reduced radiation efficiency if the antenna is not properly tuned to match the actual user characteristics.

Different wearable device users can have different characteristics (e.g., different radii, tissue composition, varying band tightness), and so detuning shifts on the order of 100-175 MHz can occur. These frequency response offsets can correspond to severe performance degradation in some LTE bands, such as those below 1 GHz where dielectric detuning effects may be more prominent. For example, a watch antenna tuned to 700 MHz in phantom testing can exhibit effective S11 of about −3 dB when worn on certain wrists, losing roughly 50% of radiated energy. To overcome this challenge, the controller can store data corresponding to sets of measured S11 curves for both phantom and different types of user wrist load conditions, along with optimal matching configurations for each case. The controller can process the live sensor data (e.g., sensor measurements to determine or identify which curve of the set of curves (e.g., load distribution profiles) most closely matches the current wear condition, and make the adjustment in the impedance matching network 908 to correct the frequency performance of the antenna to account for the return loss characteristic by selecting a matching tune code for the given load distribution.

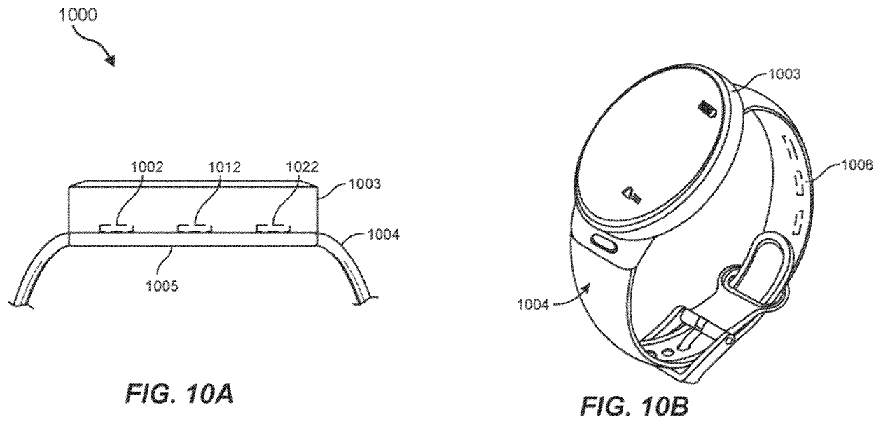

For example, the controller can derive the load distribution profile from measurements detected by the set of sensors 1002, 1012, 1022 (shown in FIG. 10) disposed in the smartwatch body 1003 (e.g., the capsule) and the band sensors 1006 along the wrist band 1004. The measurements from the capsule sensors 1002, 1012, 1022 can indicate the contact forces between the underside of the smartwatch body 1003 and the portion of the user's wrist in direct contact with the body 1003, while the measurements from the band sensors 1006 can indicate tensile forces, strains, or pressures along the interior circumference of the wrist band 1004. The controller can process these measurements to determine a load distribution profile, which can correspond to a representation of relative magnitudes and positions of mechanical interaction forces detected at the different sensor locations. The load distribution profile can identify wearing conditions such as uniform contact pressure around the capsule and band, partial contact concentrated toward one side of the capsule, or minimal contact as in a loose-fit condition. For each of these wearing conditions, the controller can retrieve from memory a stored return-loss characteristic associated with the corresponding load distribution profile, and select a tune code defining configuration settings for components of the impedance-matching network 908 that will adjust the frequency response of the antenna 906 to match the return-loss characteristic, thereby maintaining optimal wireless performance.

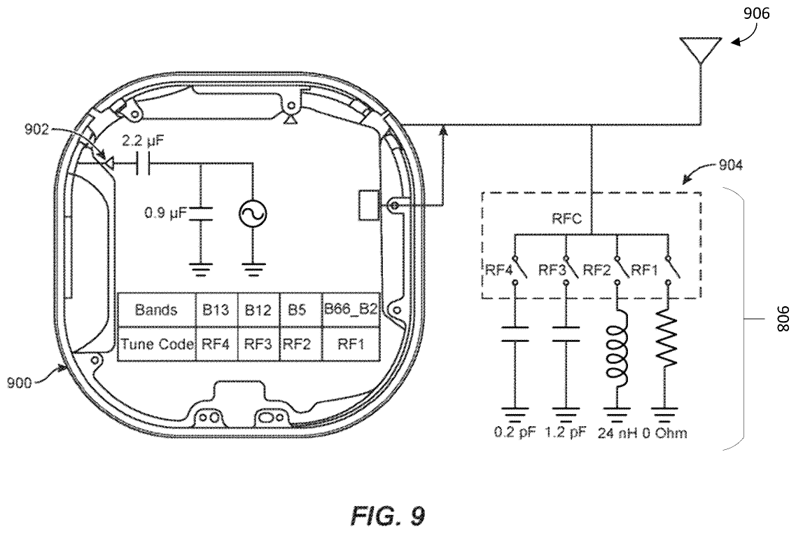

FIG. 9 illustrates an example system selecting or applying antenna tune codes 900 and a corresponding schematic of the antenna tunning circuit 902 for a smartwatch. The antenna of the smartwatch may operate across multiple frequency bands (e.g., B13, B12, B5, B66_B2) as illustrated in FIG. 9. Antenna tuning circuit 902, also referred as the tuner 902, may include variable capacitors and an inductor indicating a tunable antenna system. The tuner 902 can be controlled by the controller to select antenna tune codes 900 and adjust the antenna operation.

Antenna tune codes 900 such as RF4, RF3, RF2, and RF1 may refer to the capacitor values and switch terminations for adjusting the impedance of the antenna. Furthermore, a radio frequency (RF) transceiver 904 may control the switch terminations, as illustrated in FIG. 9, to optimize the antenna tune code 900 at each specific band. For instance, by controlling RFC switches (e.g., RF1, RF2, RF3, RF4) which can be coupled with or activate any particular one or more capacitors, inductors and/or resistors of an impedance matching network, the transceiver 904 can cause the antenna 906 to operate in accordance with a particular frequency adjustment that reduces or minimizes the return loss of the antenna, based on the return loss characteristics of the smartwatch device interaction with the body of the user wearing the device.

The tune codes 900 can correspond to various bands associated with different frequency ranges. The tune codes can be selected, managed or controlled by a controller, which can be any combination of hardware and software for utilizing sensor measurements for adjusting antenna operation based on return loss. The controller can include, for example, any processor or a controller circuit, such as a microcontroller in FIG. 5, a microprocessor or a system on a chip (SoP) in FIG. 6, or a controller 1875 in FIG. 18. For instance, the controller can be operably coupled with a set of sensors, such as sensors 1002, 1012 or 1022 on smartwatch body 1003 and sensors 1006 disposed along the interior surface of the watch band 1004, as illustrated in FIGS. 10A and 10B. These sensors can generate measurements that are indicative of interaction (e.g., forces, pressure, tension, ohmic resistance, electrical conductivity or other characteristics) between a portion of a body of a user (e.g., a user's wrist) on the one side and the smartwatch body 1003 and the watch band 1004, on the other.

The controller can be configured (e.g., via instructions stored in memory and executed by controller circuitry) to utilize the sensor measurements corresponding to the interaction in order to determine, compute or identify a load distribution induced by the portion of the body of the user (e.g., the user's wrist) against the smartwatch. The load distribution can correspond to a profile of sensor measurements from the set of sensors that includes sensors distributed along the watch band 1004 and smartwatch body 1003. The measurement profile can indicate a particular type of tightness, pressures or any other interactions between a wrist of a user one the one side and the smartwatch body 1003 and band 1004. The controller can determine, based on the distribution of load, a return loss characteristic of the antenna associated with the portion of the body of the user. The return loss characteristic can include a frequency energy loss distribution, such as those illustrated in the plots of FIG. 8. The return loss characteristic can include reflected energy properties as a function of frequency of signal communicated via the antenna of the smartwatch body 1003, including a minimum loss signal at a particular frequency point, which can be particular to the user or the measurement profile. Upon determining the return loss characteristic, the controller can adjust a frequency response of the antenna according to the return loss characteristic. For instance, the controller can adjust or activate particular tune code 900, including activation of particular switches of an impedance matching network 908, such as by activating or switching any of RF1, RF2, RF3 or RF4 switches in FIG. 9, to fine tune the operation of the transceiver 904 and/or the antenna 906 and minimize the return loss of the antenna.

Turning to FIGS. 10A and 10B, smartwatch 1000 may illustrate a watch body 1003 and a watch band 1004 of a smartwatch 1000. Watch body 1003 and watch band 1004 may have a substantially, rectangular, hexagonal, octagonal or circular shape and may be configured to allow a user to wear smartwatch 1000 on a body part (e.g., a human wrist, test phantom). In some cases, the watch body 1003 may be referred to as a “capsule.” As illustrated in FIG. 10A, watch body 1003 may include a set of capsule sensors 1002, 1012, and 1022 inside watch body 1003. For example, capsule sensors 1002, 1012, and 1022 may detect a change in force and/or strain on a bottom cover 1005 of the watch body 1003 when a user dons on smartwatch 1000. Referring to FIG. 10B, watch band 1004 may include a set of band sensors 1006 for detecting band tightness on a user. In some embodiments, smartwatch 1000 may include both capsule sensors 1002, 1012, and 1022 and band sensors 1006. In further embodiments, smartwatch 1000 may include capsule sensors 1002, 1012, and 1022 or band sensors 1006.

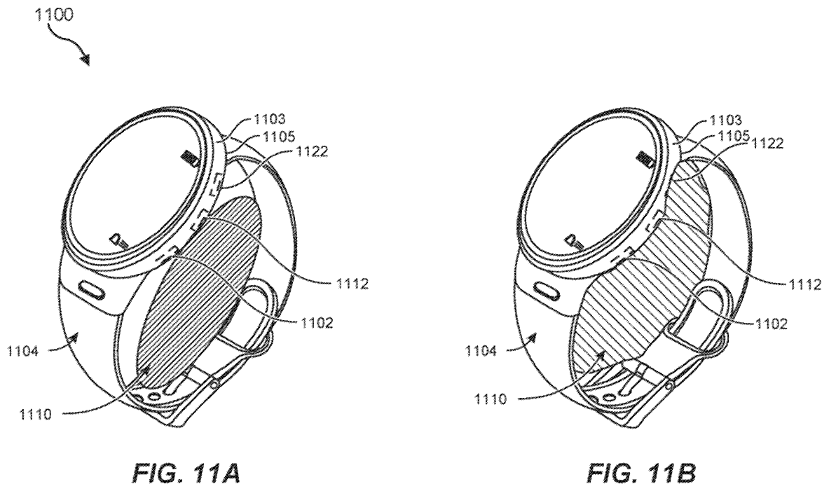

FIGS. 11A and 11B illustrate a smartwatch 1100 donned on a test phantom and a human wrist 1110. As illustrated in FIG. 11A, test phantom may be used for testing a smartwatch 1100 that includes a watch body 1103 and watch band 1104. As used herein, “test phantom” may refer to a material that mimics a human wrist for use by cellular carriers to assess and optimize the performance of their network antennas. In this manner, capsule sensors 1102 may assess a force and/or strain associated with test phantom and allow cellular carriers to estimate how much tuning may be required for optimal antenna performance on a human wrist.

As illustrated in FIG. 11B, capsule sensors 1102, 1112, and 1122 may be placed inside watch body 1103 for detecting a force and/or strain on a bottom cover 1105 of the watch body 1103 when a human wrist 1110 dons on smartwatch 1100. Watch band 1104 may be configured to be worn by human wrist 1110 such that an inner surface of watch band 1104 may be in contact with the user's skin. Upon capsule sensors 1102, 1112, and 1122 detecting a change in the environment surrounding the antennas (not pictured) inside smartwatch 1100, the detected change from capsule sensors 1102, 1112, and 1122 may be used to tune one or more antennas for optimal antenna performance. For example, once the capsule sensors 1102 detect, based on an input, a change in one or more specified operational parameters associated with at least one antenna, a radio frequency (RF) transceiver in watch body 1103 may be configured to control a dynamic tuner to change the one or more specified operational parameters of the at least one antenna based on the input detected from the capsule sensors 1102, 1112, and 1122. In this manner, antenna tune code may be dynamically varied by the RF transceiver, upon receiving a detected change in force and/or strain when the human wrist 1110 dons on smartwatch 1100.

In some embodiments, if capsule sensor 1112 has a greater force value than capsule sensors 1102 and 1122 in smartwatch 1100 donned on test phantom, the corresponding antenna tune code may be applied to accommodate for the larger force impacting antenna performance. In some embodiments, if the detected force values from sensor 1112 and sensor 1102 and/or sensor 1112 and sensor 1122 are equal in smartwatch 1100 donned on human wrist 1110, the corresponding antenna tune code for maximum dielectric loading may be applied for optimal antenna performance. In some embodiments, if smartwatch 1100 is tilted towards the user, creating a greater force on capsule sensor 1102 than capsule sensor 1122, the corresponding antenna tune code for a partial loading condition may be applied. In some embodiments, if smartwatch 1100 is tilted away from the user, creating a greater force on capsule sensor 1122 than capsule sensor 1102, the corresponding antenna tune code for a partial loading condition may be applied.

For instance, the controller can classify the determined load distribution profile into one of multiple predetermined wearing condition categories stored in memory that can be coupled with the processing circuitry of the controller. Each category can be associated with a return-loss characteristic of antenna 906 that was measured under that wearing condition during calibration, and a corresponding impedance-matching configuration for network 908. For example, a rigid CTIA test phantom category can be associated with a tune code selected to match the return-loss characteristic measured for the phantom, whereas a maximum dielectric loading category can be associated with a tune code selected to center the S11 minimum at a specific operating frequency when worn on a human wrist. Categories corresponding to partial contact toward first antenna 1205 or second antenna 1206 can be associated with adjusting the opposite-side antenna while applying an impedance-matching configuration based on the measured return-loss characteristic for that contact condition. In certain examples, categories can further distinguish between tight-fit and loose-fit variants based on tensile forces detected by sensors 1006 in wrist band 1004, allowing the controller to compensate for frequency shifts caused by changes in loading.

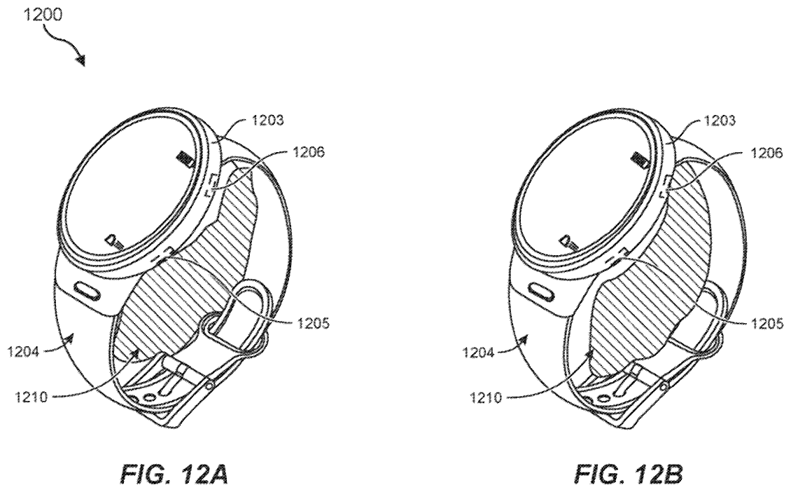

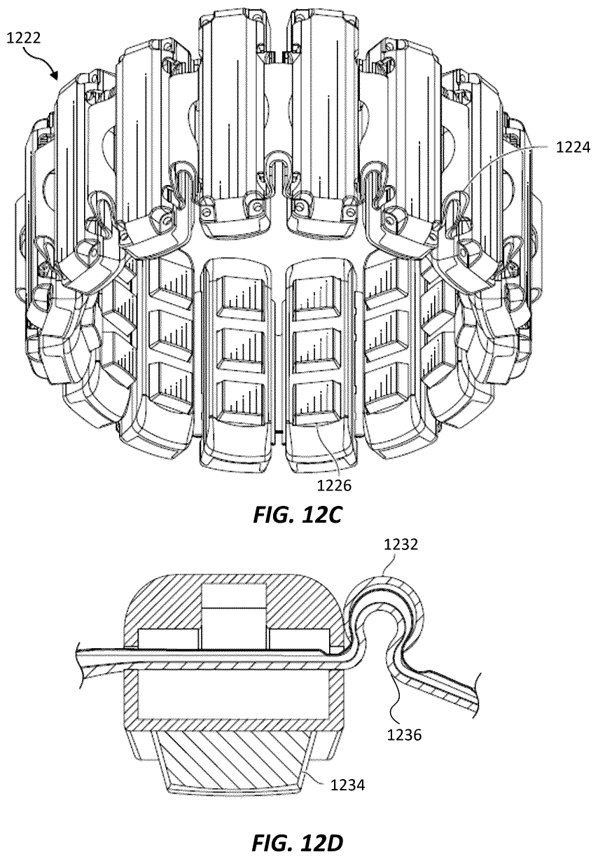

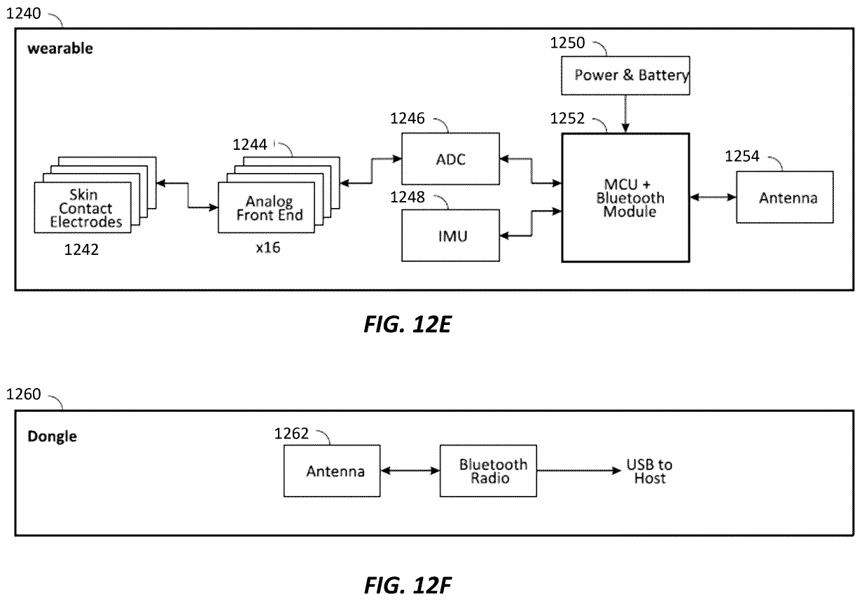

Turning to FIGS. 12A and 12B, smartwatch 1200 illustrate a watch body 1203 including a first antenna 1205 and a second antenna 1206 and a watch band 1204. FIG. 12A may illustrate smartwatch 1200 tilted towards a user, where a top portion of a human wrist 1210 is in contact with the first antenna 1205, but not in contact with second antenna 1206. In some embodiments, because the human skin of human wrist 1210 may absorb signals going to first antenna 1205, first antenna 1205 may be turned off and second antenna 1206 may be turned on for optimal antenna performance, as illustrated in FIG. 12A. Conversely, FIG. 12B illustrates smartwatch 1200 tilted away from the user, where a top portion of human wrist 1210 is in contact with the second antenna 1206, but not in contact with first antenna 1205. In some embodiments, second antenna 1206 may be turned off and first antenna 1205 may be turned on for optimal antenna performance, as illustrated in FIG. 12B.

In some instances, the controller can perform antenna selection in combination with impedance tuning of the active antenna to further improve performance. For instance, when the load distribution profile indicates partial loading concentrated toward antenna 1205, the controller can disable antenna 1205, enable antenna 1206, and select a tune code with defined settings for components of impedance-matching network 908 coupled to antenna 1206. This tune code can be determined from a stored association between the measured load distribution profile and a return-loss characteristic for antenna 1206 under similar conditions, enabling the frequency response of the active antenna to remain centered on the desired operating band. Applying such hybrid switching and tuning approach can reduce absorption losses attributable to wrist contact while maintaining desired return-loss performance.

FIG. 12C illustrates an exemplary human-machine interface (also referred to herein as an EMG control interface) configured to be worn around a user's lower arm or wrist as a wearable system 1222. In some examples, the wearable system 1222 can include, correspond to, or comprise a wearable device, such as a smartwatch with a body portion (e.g., comprising a smartwatch with its internal electronics, circuitries and displays) and a band portion comprising a wrist band. Both the body and the band can include one or more sensors. In an example, wearable system 1200 may include sixteen neuromuscular sensors 1226 (e.g., EMG sensors) arranged circumferentially around an elastic band 1224 with an interior surface 1236 configured to contact a user's skin. However, any suitable number of neuromuscular sensors may be used. The number and arrangement of neuromuscular sensors may depend on the particular application for which the wearable device is used. For example, a wearable armband or wristband can be used to generate control information for controlling an augmented reality system, a robot, controlling a vehicle, scrolling through text, controlling a virtual avatar, or any other suitable control task. As shown, the sensors may be coupled together using flexible electronics incorporated into the wireless device.

FIG. 12D illustrates a cross-sectional view through one of the sensors of the wearable device shown in FIG. 12A. In some embodiments, the output of one or more of the sensing components can be optionally processed using hardware signal processing circuitry (e.g., to perform amplification, filtering, and/or rectification). In other embodiments, at least some signal processing of the output of the sensing components can be performed in software. Thus, signal processing of signals sampled by the sensors can be performed in hardware, software, or by any suitable combination of hardware and software, as aspects of the technology described herein are not limited in this respect. A non-limiting example of a signal processing chain used to process recorded data from sensors 1226 is discussed in more detail below with reference to FIGS. 12E and 12F.

FIGS. 12E and 12F illustrate an exemplary schematic diagram with internal components of a wearable system with EMG sensors. As shown, the wearable system may include a wearable portion 1240 (FIG. 12E) and a dongle portion 1260 (FIG. 12F) in communication with the wearable portion 1240 (e.g., via BLUETOOTH or another suitable wireless communication technology). As shown in FIG. 12E, the wearable portion 710 may include skin contact electrodes 711, examples of which are described in connection with FIGS. 12C and 12D. The output of the skin contact electrodes 1242 (e.g., sensors) may be provided to analog front end 1244, which may be configured to perform analog processing (e.g., amplification, noise reduction, filtering, etc.) on the recorded signals. The processed analog signals may then be provided to analog-to-digital converter (ADC) 1246, which may convert the analog signals to digital signals that can be processed by one or more computer processors. An example of a computer processor that may be used in accordance with some embodiments is microcontroller (MCU) 1252, illustrated in FIG. 12E. As shown, MCU 1252 may also include inputs from other sensors (e.g., IMU sensor 1248), and power and battery module 1250. The output of the processing performed by MCU 1252 may be provided to antenna 1254 for transmission to dongle portion 1260 shown in FIG. 12F.

Dongle portion 1260 may include antenna 1262, which may be configured to communicate with antenna 1254 included as part of wearable portion 1240. Communication between antennas 1254 and 1262 may occur using any suitable wireless technology and protocol, non-limiting examples of which include radiofrequency signaling and BLUETOOTH. As shown, the signals received by antenna 1262 of dongle portion 1260 may be provided to a host computer for further processing, display, and/or for effecting control of a particular physical or virtual object or objects.

Although the examples provided with reference to FIGS. 12C-12D and FIGS. 12E-12F are discussed in the context of interfaces with EMG sensors, the techniques described herein for reducing electromagnetic interference can also be implemented in wearable interfaces with other types of sensors including, but not limited to, mechanomyography (MMG) sensors, sonomyography (SMG) sensors, and electrical impedance tomography (EIT) sensors. The techniques described herein for reducing electromagnetic interference can also be implemented in wearable interfaces that communicate with computer hosts through wires and cables (e.g., USB cables, optical fiber cables, etc.).

For instance, EMG sensors 1226 can be configured to measure electrode-skin contact impedance in addition to detecting sensor signals (e.g., neuromuscular measurements). Variations in such contact impedance can indicate changes in band tightness or localized pressure points along interior surface 1236 of band 1004 and/or smartwatch body 1003. The controller can use impedance measurements, alone or combined with measurements from force sensors 1002, 1012, 1022 and tension sensors 1006, to determine the load distribution profile. The determined profile can then be used to identify the corresponding return-loss characteristic of antenna 906 and to select a tune code for impedance-matching network 908 that adjusts the antenna's frequency response in accordance with that characteristic. For example, analog front end 1244 can measure impedance for the EMG sensor channels without interrupting neuromuscular signal acquisition, allowing for the same set of sensors to support gesture detection and real-time or periodic antenna tuning or retuning.

Referring to FIG. 13, fluidic valve 1300 may include a gate 1320 for controlling the fluid flow through fluid channel 1310. Gate 1320 may include a gate transmission element 1322, which may be a movable component that is configured to transmit an input force, pressure, or displacement to a restricting region 1324 to restrict or stop flow through the fluid channel 1310. Conversely, in some examples, application of a force, pressure, or displacement to gate transmission element 1322 may result in opening restricting region 1324 to allow or increase flow through the fluid channel 1310. The force, pressure, or displacement applied to gate transmission element 1322 may be referred to as a gate force, gate pressure, or gate displacement. Gate transmission element 1322 may be a flexible element (e.g., an elastomeric membrane, a diaphragm, etc.), a rigid element (e.g., a movable piston, a lever, etc.), or a combination thereof (e.g., a movable piston or a lever coupled to an elastomeric membrane or diaphragm).

As illustrated in FIG. 13, gate 1320 of fluidic valve 1300 may include one or more gate terminals, such as an input gate terminal 1326(A) and an output gate terminal b 1326(B) (collectively referred to herein as “gate terminals 1326”) on opposing sides of gate transmission element 1322. Gate terminals 1326 may be elements for applying a force (e.g., pressure) to gate transmission element 1322. By way of example, gate terminals 1326 may each be or include a fluid chamber adjacent to gate transmission element 1322. Alternatively or additionally, one or more of gate terminals 1326 may include a solid component, such as a lever, screw, or piston, that is configured to apply a force to gate transmission element 1322.

In some examples, a gate port 1328 may be in fluid communication with input gate terminal 1326(A) for applying a positive or negative fluid pressure within the input gate terminal 1326(A). A control fluid source (e.g., a pressurized fluid source, a fluid pump, etc.) may be in fluid communication with gate port 1328 to selectively pressurize and/or depressurize input gate terminal 1326(A). In additional embodiments, a force or pressure may be applied at the input gate terminal 1326(A) in other ways, such as with a piezoelectric element or an electromechanical actuator, etc.

In the embodiment illustrated in FIG. 13, pressurization of the input gate terminal 1326(A) may cause the gate transmission element 1322 to be displaced toward restricting region 1324, resulting in a corresponding pressurization of output gate terminal 1326(B). Pressurization of output gate terminal 1326(B) may, in turn, cause restricting region 1324 to partially or fully restrict to reduce or stop fluid flow through the fluid channel 1310. Depressurization of input gate terminal 1326(A) may cause gate transmission element 1322 to be displaced away from restricting region 1324, resulting in a corresponding depressurization of the output gate terminal 1326(B). Depressurization of output gate terminal 1326(B) may, in turn, cause restricting region 1324 to partially or fully expand to allow or increase fluid flow through fluid channel 1310. Thus, gate 1320 of fluidic valve 1300 may be used to control fluid flow from inlet port 1312 to outlet port 1314 of fluid channel 1310.

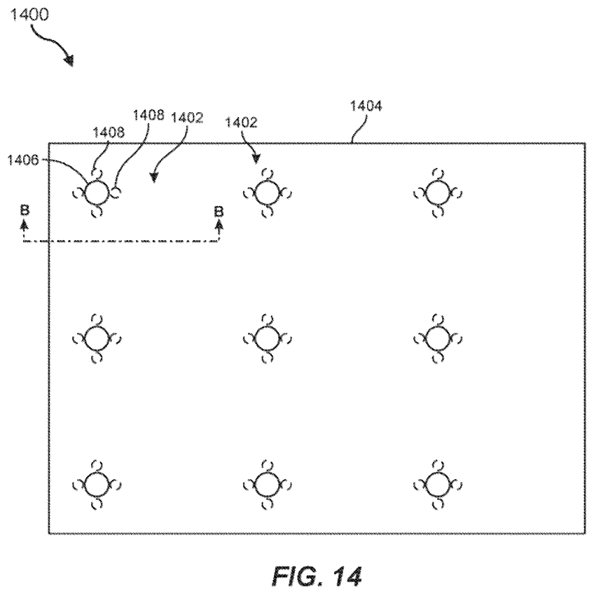

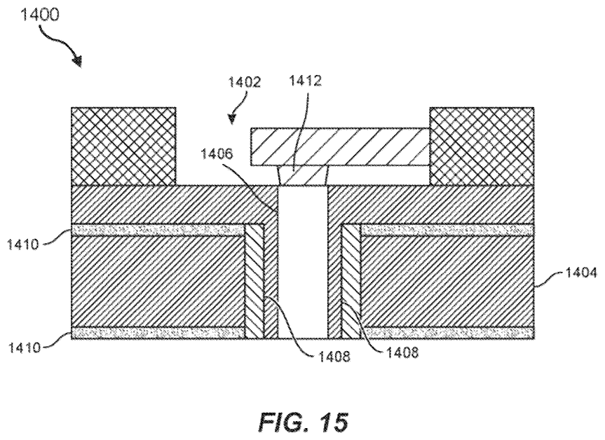

FIG. 14 is a plan view of a microvalve array 1400, taken from line A-A of FIG. 15, according to at least one embodiment of the present disclosure. The microvalve array 1400 may include a plurality of microvalves 1402 formed in a substrate 1404. Each of the microvalves 1402 may include a fluid channel 1406 through the substrate 1404 and piezoresistive materials 1408 in the substrate 1404 adjacent to the fluid channel 1406.

A valve element, illustrated in FIG. 15 and discussed below, may be configured to open and close a fluid pathway through each fluid channel 1406.

The substrate 1404 may be any substrate in which the microvalves 1402, or at least a portion of the microvalves 1402, may be formed. In some examples, the substrate 1404 may include a silicon material in which the fluid channels 1406 and the piezoresistive materials 1408 may be formed.

The piezoresistive materials 1408 may be configured and positioned to change in electrical resistance upon a change in fluid pressure within the fluid channel 1406. For example, the piezoresistive materials 1408 may include four distinct piezoresistive materials 1408 arranged to at least partially surround the fluid channel 1406. In some embodiments, the piezoresistive materials 1408 may include a polysilicon material, which exhibits piezoresistive properties. When fluid pressure changes within the fluid channel 1406, such as in the case of opening and closing the microvalves 1402, the piezoresistive materials 1408 may be stretched, compressed, and/or bent. These mechanical changes may result in a change in electrical resistance of one or more of the piezoresistive materials 1408. The change in resistance may be measured to, in turn, determine a change in pressure within the fluid channel 1406.

The measured change in pressure can be used to identify and verify when each microvalve 1402 is open, closed, or partially open. This information can be useful for a variety of reasons, such as to determine faults, to confirm proper operation of each microvalve 1402 or the microvalve array 1400 as a whole, to determine the appropriate voltage to apply to a valve element that opens and/or closes a fluid pathway through the fluid channels 1406, etc.

Additional parts of the microvalves 1402 may also be formed on or in the substrate 1404, such as circuitry to determine an electrical resistance in the piezoelectric materials 1408. Such circuitry may be integrated into the substrate 1404, such as by conventional silicon manufacturing techniques. Additionally, a valve element for opening and/or closing the fluid pathway through each fluid channel 1406 may be formed over the substrate 1404, as explained below.

FIG. 15 is a side cross-sectional view of a microvalve 1402 of the microvalve array 1400 of FIG. 14, taken from line B-B of FIG. 14, according to at least one embodiment of the present disclosure. As shown in FIG. 15, the fluid channel 1406 may pass through the substrate 1404, and the piezoelectric materials 1408 may extend adjacent to and along at least a portion of the fluid channel 1406. Circuitry 1410 (e.g., conductive traces) may be within the substrate 1404 and connected to the piezoelectric materials 1408. The circuitry 1410 may be configured for sensing a change in electrical resistivity of one or more of the piezoelectric materials 1408, and thereby for determining a change in fluid pressure within the fluid channel 1406. The circuitry 1410 and the piezoelectric materials 1408 may form a Wheatstone bridge circuit.

The microvalves 1402 of FIGS. 14 and 15 have been illustrated and described as each including four piezoelectric materials 1408 at least partially surrounding each fluid channel 1406. However, the present disclosure is not so limited. For example, the elements shown as piezoelectric materials 1408 may include one piezoelectric material 1408 having a variable resistance (e.g., to form a so-called “quarter bridge” Wheatstone bridge circuit), two piezoelectric materials 1408 having a variable resistance (e.g., to form a so-called “half-bridge” Wheatstone bridge circuit), or four piezoelectric materials 1408 having a variable resistance (e.g., to form a so-called “full bridge”Wheatstone bridge circuit).

Each of the microvalves 1402 may include a valve element 1412 configured to open and close a fluid pathway through the fluid channel 1406. In some examples, as illustrated in FIG. 15, the valve element 1412 may be or include a cantilevered valve plug. In additional examples, the valve element 1412 may be or include a ball, a plunger, a slider, a bubble, a flexible diaphragm, or the like. The valve element 1412 may be formed as a part of the substrate 1404, or may be formed separately and then coupled to the substrate 1404.

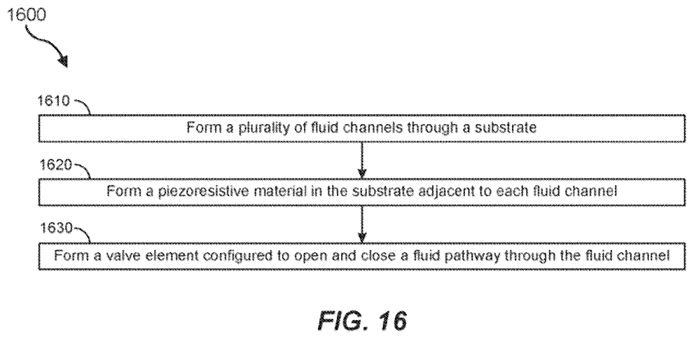

FIG. 16 is a flow diagram illustrating a method 1600 of forming a microvalve array, according to at least one embodiment of the present disclosure. At operation 1610, a plurality of fluid channels may be formed through a substrate. Operation 1610 may be performed in a variety of ways, such as photolithography, laser ablation, or another material removal process may be performed to form the fluid channels through the substrate (e.g., a silicon substrate).

At operation 1620, a piezoresistive material (e.g., polysilicon) may be formed adjacent to each fluid channel of the plurality of fluid channels. The piezoresistive material may be configured to change in electrical resistance upon a change in fluid pressure within the fluid channel. Operation 1620 may be performed in a variety of ways. For example, holes may be formed in the substrate, and the holes may be filled with the piezoresistive material. In additional examples, the substrate may be modified to result in the piezoresistive material, such as through doping, heat-treating, etc.

At operation 1630, a valve element may be formed, which may be configured to open and close a fluid pathway through the fluid channel. Operation 1630 may be performed in a variety of ways. For example, the valve element may be formed as part of the substrate or may be formed separately and then coupled to the substrate.

Accordingly, the present disclosure relates to microvalves and microvalve arrays that may include integrated pressure gauges, which may be used to sense whether, when, and to what extent the microvalves are functioning properly. In addition, the integration of the pressure gauges may reduce a complexity and cost of microvalve arrays that include pressure-based feedback capabilities.

### EXAMPLE EMBODIMENTS

In some embodiments, an apparatus for concealed optical sensors can include a housing comprising a housing shell, the housing shell being configured to permit light to pass through a passthrough region of the housing shell as well as an ambient light sensor, positioned to detect light that passes through the passthrough region of the housing shell.

In some examples, the passthrough region of the apparatus can include a region of the housing shell that is thinner than an adjoining region of the housing shell. Additionally or alternatively, the region may include a shell brace that is substantially optically transparent and is coupled to the passthrough region of the housing shell to structurally reinforce the region of the housing shell that is thinner than the adjoining region of the housing shell.

In some examples, the ambient light sensor can be mounted on a substrate that has a similar color to the housing shell.

In some embodiments, the outer surface of the housing shell can be textured to improve light scattering of light passing through the housing shell. Additionally or alternatively, an inner surface of the housing shell can be textured to improve light scattering of light passing through the housing shell. In further embodiments, a surface of the housing shell can be shaped to act as a light-guiding material to direct light to the ambient light sensor.

In some examples, the housing shell can be made up of a single contiguous piece of material.

In some embodiments, the passthrough region of the housing shell can be configured to allow an average of 12% of light to pass through the passthrough region to the ambient light sensor.

In one embodiment, a system for concealing optical sensors can include a camera, a housing with a housing shell that is configured to permit light to pass through a passthrough region of the housing shell, an ambient light sensor that is positioned to detect light that passes through the passthrough region of the housing shell, and camera control circuitry that is configured to adjust a function of the at least one camera based on information received from the ambient light sensor.

In some embodiments, a system where the passthrough region can include a region of the housing shell that is thinner than an adjoining region of the housing shell.

In some embodiments, a system further including a shell brace that is substantially optically transparent and is coupled to the passthrough region of the housing shell to structurally reinforce the region of the housing shell that is thinner than the adjoining region of the housing shell.

In some embodiments, a system where the ambient light sensor is mounted on a substrate that is colored with a similar color to the housing shell.

In some embodiments, a system where an outer surface of the housing shell is textured to improve light scattering of light passing through the housing shell.

In some embodiments, a system where an inner surface of the housing shell is textured to improve light scattering of light passing through the housing shell.

In some embodiments, a system where a surface of the housing shell is shaped to act as a light-guiding material to direct light to the ambient light sensor.

In some embodiments, a system where the housing shell comprises a single contiguous piece of material.

In some embodiments, a system where the passthrough region of the housing shell is configured to allow an average of 12% of light to pass through the passthrough region to the ambient light sensor.

In some embodiments, a system where the ambient light sensor comprises an ambient light flicker sensor.

In one embodiment, a method including sensing a temperature value of a battery circuit, activating a heat dissipation element within the battery circuit when the temperature value reaches a threshold, discharging heat from the battery circuit via the activated heat dissipation element, and deactivating the heat dissipation element when the temperature value falls below the threshold.

In one embodiment, a system including a battery, an antenna, a radio frequency coupler, operably placed in a transmit path of the antenna, that is configured to generate an output signal detailing an amount of power reflected back to a radio frequency power amplifier, a radio frequency signal conditioning circuitry that is configured to (i) receive the output signal from the radio frequency coupler and (ii) convert the output signal for processing by an analog to digital converter and a microprocessor that is configured to adjust a charging voltage for the battery based on whether a change in a thickness displacement of the battery, calculated from the output signal, exceeds a swelling response threshold.

In some embodiments, where the microprocessor is configured to adjust an antenna tuner, for impedance matching of the antenna, based on the change in the thickness displacement of the battery calculated from the output signal.

In one embodiment, a smartwatch includes a watch body, a watch band configured to support the watch body, a set of sensors in the watch body and a set of sensors in the watch band configured to, detect, based on an input, a change in one or more specified operational parameters associated with at least one antenna, a radio frequency transceiver in the watch body, and a dynamic tuner operably coupled to the radio frequency transceiver and a ground plane in the watch body, where the radio frequency transceiver is configured to control the dynamic tuner to change the one or more specified operational parameters of the at least one antenna based on the input detected from the set of sensors in the watch body and the set of sensors in the watch band.

In one embodiment, a microvalve array includes a plurality of microvalves, each microvalve of the plurality of microvalves comprising a substrate, a fluid channel through the substrate, a valve element configured to open and close a fluid pathway through the fluid channel, and a piezoresistive material in the substrate adjacent to the fluid channel, the piezoresistive material being configured to change in electrical resistance upon a change in fluid pressure within the fluid channel.

In some embodiments, the microvalve array may include the piezoresistive material including polysilicon.

In some embodiments, the microvalve array may include the substrate including a silicon substrate.

In some embodiments, the microvalve array may include the piezoresistive material including four distinct piezoresistive materials arranged to at least partially surround the fluid channel.

In some embodiments, the microvalve array further including electrical circuitry is operably coupled to the four distinct piezoresistive materials to form a Wheatstone bridge including the four distinct piezoresistive materials.

In some embodiments, the microvalve array may include the valve element including a cantilevered valve plug configured to open and close the fluid channel.

In one embodiment, a method of forming a microvalve array, the method including forming a plurality of fluid channels through a substrate, forming a piezoresistive material in the substrate adjacent to each fluid channel of the plurality of fluid channels, the piezoresistive material being configured to change in electrical resistance upon a change in fluid pressure within the fluid channel, and forming a valve element configured to open and close a fluid pathway through the fluid channel.

In some embodiments, the method further including connecting circuitry to the piezoresistive material to sense a change in electrical resistance in the piezoresistive material and to thereby sense the change in fluid pressure within the fluid channel.

In some embodiments, the method where forming the piezoresistive material in the substrate comprises forming a polysilicon material in the substrate.

In some embodiments, the method of forming the piezoresistive material in the substrate comprises forming four distinct piezoresistive materials adjacent to each fluid channel of the plurality of fluid channels.

In some embodiments, the method further including forming a Wheatstone bridge including the four distinct piezoresistive materials as resistors in the Wheatstone bridge.

In some embodiments, the artificial reality devices and/or accessory devices disclosed herein may include haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons). In some examples, cutaneous feedback may include vibration, force, traction, texture, and/or temperature. Similarly, kinesthetic feedback, may include motion and compliance. Cutaneous and/or kinesthetic feedback may be provided using motors, piezoelectric actuators, fluidic systems, and/or a variety of other types of feedback mechanisms. Furthermore, haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The haptics assemblies disclosed herein may enable or enhance a user's artificial-reality experience in one or more of these contexts and environments and/or in other contexts and environments.

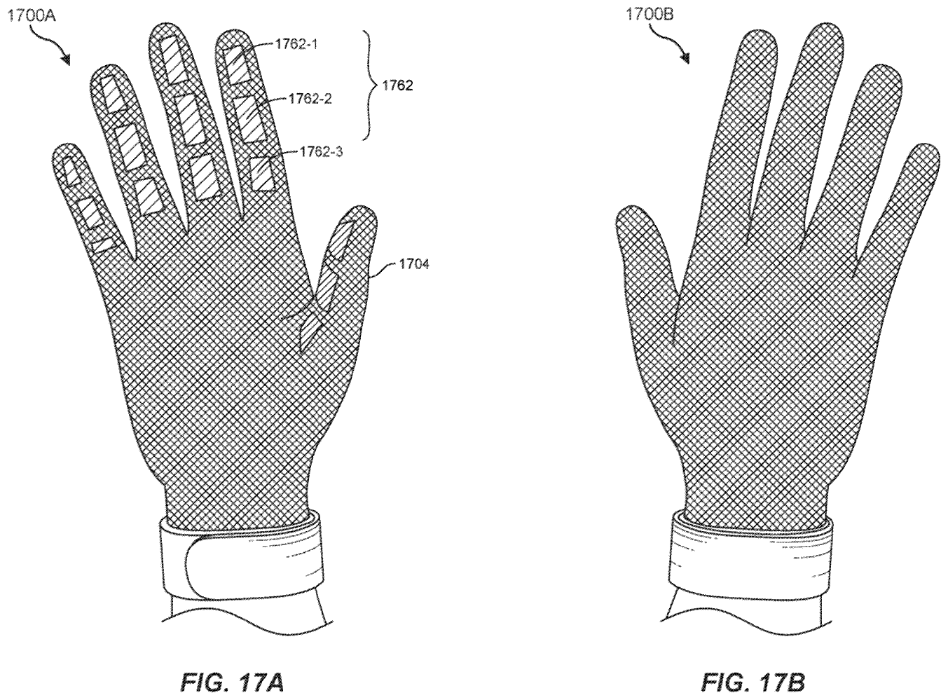

FIGS. 17A and 17B show example haptic feedback systems (e.g., hand-wearable devices) for providing feedback to a user regarding the user's interactions with a computing system (e.g., an artificial-reality environment presented by the AR system 2500 or the VR system 2610). In some embodiments, a computing system (e.g., the AR systems 2100 and/or 2200) may also provide feedback to one or more users based on an action that was performed within the computing system and/or an interaction provided by the AR system (e.g., which may be based on instructions that are executed in conjunction with performing operations of an application of the computing system). Such feedback may include visual and/or audio feedback and may also include haptic feedback provided by a haptic assembly, such as one or more haptic assemblies 1762 of haptic device 1700 (e.g., haptic assemblies 1762-1, 1762-2, 1762-3, etc.). For example, the haptic feedback may prevent (or, at a minimum, hinder/resist movement of) one or more fingers of a user from bending past a certain point to simulate the sensation of touching a solid coffee mug. In actuating such haptic effects, haptic device 1700 can change (either directly or indirectly) a pressurized state of one or more of haptic assemblies 1762.

Haptic device 1700 may optionally include other subsystems and components, such as touch-sensitive pads, pressure sensors, motion sensors, position sensors, lighting elements, and/or user interface elements (e.g., an on/off button, a vibration control element, etc.). During use, haptic assemblies 1762 may be configured to be activated for a variety of different reasons, such as in response to the user's interaction with user interface elements, a signal from the motion or position sensors, a signal from the touch-sensitive pads, a signal from the pressure sensors, a signal from the other device or system, etc.

In FIGS. 17A and 17B, each of haptic assemblies 1762 may include a mechanism that, at a minimum, provides resistance when the respective haptic assembly 1762 is transitioned from a first pressurized state (e.g., atmospheric pressure or deflated) to a second pressurized state (e.g., inflated to a threshold pressure). Structures of haptic assemblies 1762 can be integrated into various devices configured to be in contact or proximity to a user's skin, including, but not limited to devices such as glove worn devices, body worn clothing device, headset devices.

As noted above, haptic assemblies 1762 described herein can be configured to transition between a first pressurized state and a second pressurized state to provide haptic feedback to the user. Due to the ever-changing nature of artificial-reality, haptic assemblies 1762 may be required to transition between the two states hundreds, or perhaps thousands of times, during a single use. Thus, haptic assemblies 1762 described herein are durable and designed to quickly transition from state to state. To provide some context, in the first pressurized state, haptic assemblies 1762 do not impede free movement of a portion of the wearer's body. For example, one or more haptic assemblies 1762 incorporated into a glove are made from flexible materials that do not impede free movement of the wearer's hand and fingers (e.g., an electrostatic-zipping actuator). Haptic assemblies 1762 may be configured to conform to a shape of the portion of the wearer's body when in the first pressurized state. However, once in the second pressurized state, haptic assemblies 1762 can be configured to restrict and/or impede free movement of the portion of the wearer's body (e.g., appendages of the user's hand). For example, the respective haptic assembly 1762 (or multiple respective haptic assemblies) can restrict movement of a wearer's finger (e.g., prevent the finger from curling or extending) when haptic assembly 1762 is in the second pressurized state. Moreover, once in the second pressurized state, haptic assemblies 1762 may take different shapes, with some haptic assemblies 1762 configured to take a planar, rigid shape (e.g., flat and rigid), while some other haptic assemblies 1762 are configured to curve or bend, at least partially.

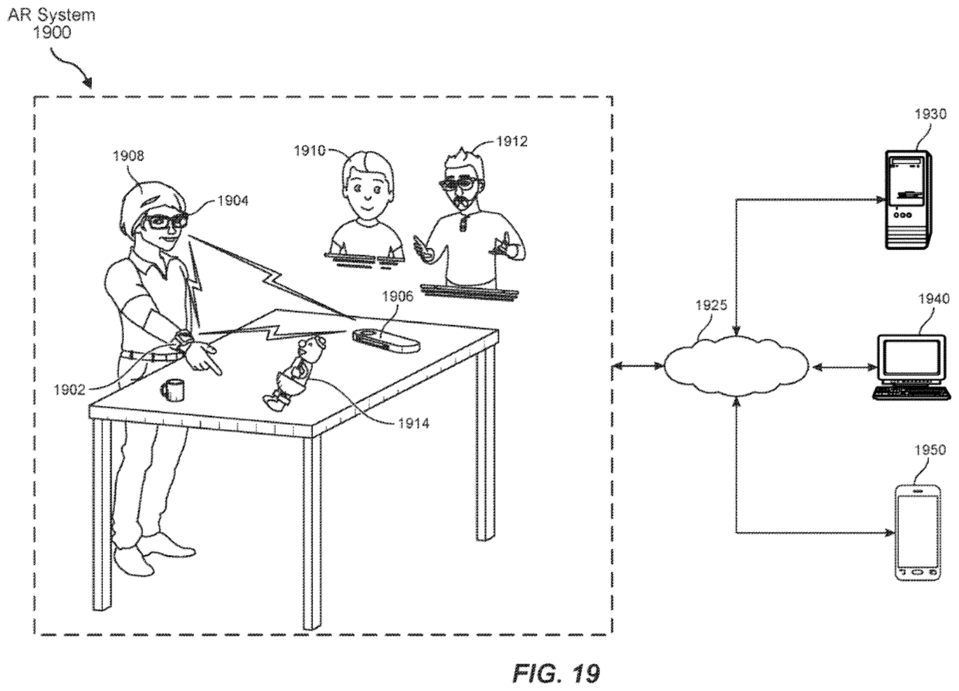

As a non-limiting example, haptic device 1700 includes a plurality of haptic devices (e.g., a pair of haptic gloves, a haptics component of a wrist-wearable device (e.g., any of the wrist-wearable devices described with respect to FIGS. 19-23), etc.), each of which can include a garment component (e.g., a garment 1704) and one or more haptic assemblies coupled (e.g., physically coupled) to the garment component. For example, each of the haptic assemblies 1762-1, 1762-2, 1762-3,. 1762-N are physically coupled to the garment 1704 and are configured to contact respective phalanges of a user's thumb and fingers. As explained above, haptic assemblies 1762 are configured to provide haptic simulations to a wearer of device 1700. Garment 1704 of each device 1700 can be one of various articles of clothing (e.g., gloves, socks, shirts, pants, etc.). Thus, a user may wear multiple haptic devices 1700 that are each configured to provide haptic stimulations to respective parts of the body where haptic devices 1700 are being worn.

FIG. 18 shows block diagrams of a computing system 1840 of haptic device 1700, in accordance with some embodiments. Computing system 1840 can include one or more peripherals interfaces 1850, one or more power systems 1895, one or more controllers 1875 (including one or more haptic controllers 1876), one or more processors 1877 (as defined above, including any of the examples provided), and memory 1878, which can all be in electronic communication with each other. For example, one or more processors 1877 can be configured to execute instructions stored in the memory 1878, which can cause a controller of the one or more controllers 1875 to cause operations to be performed at one or more peripheral devices of peripherals interface 1850. In some embodiments, each operation described can occur based on electrical power provided by the power system 1895. The power system 1895 can include a charger input 1896, a PMIC 1897, and a battery 1898.

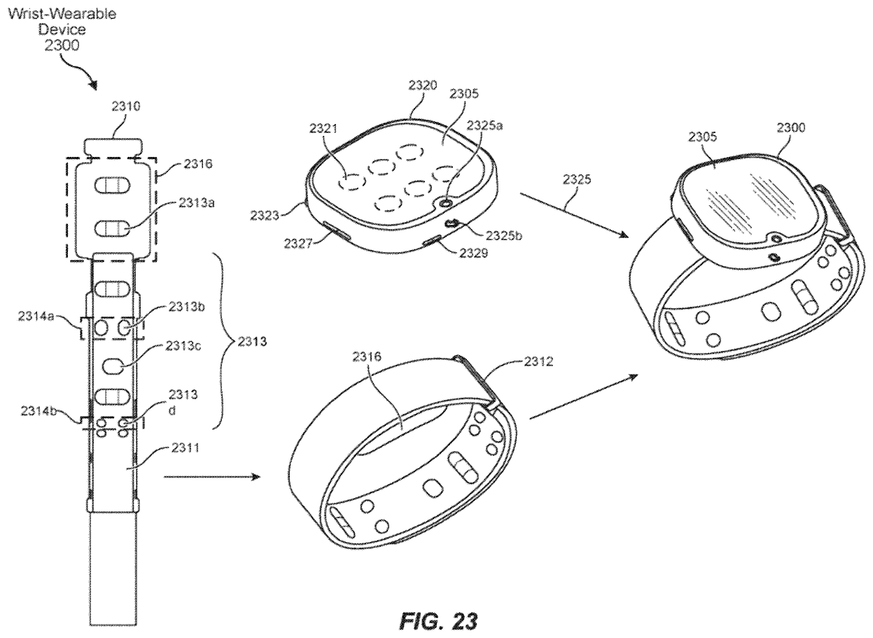

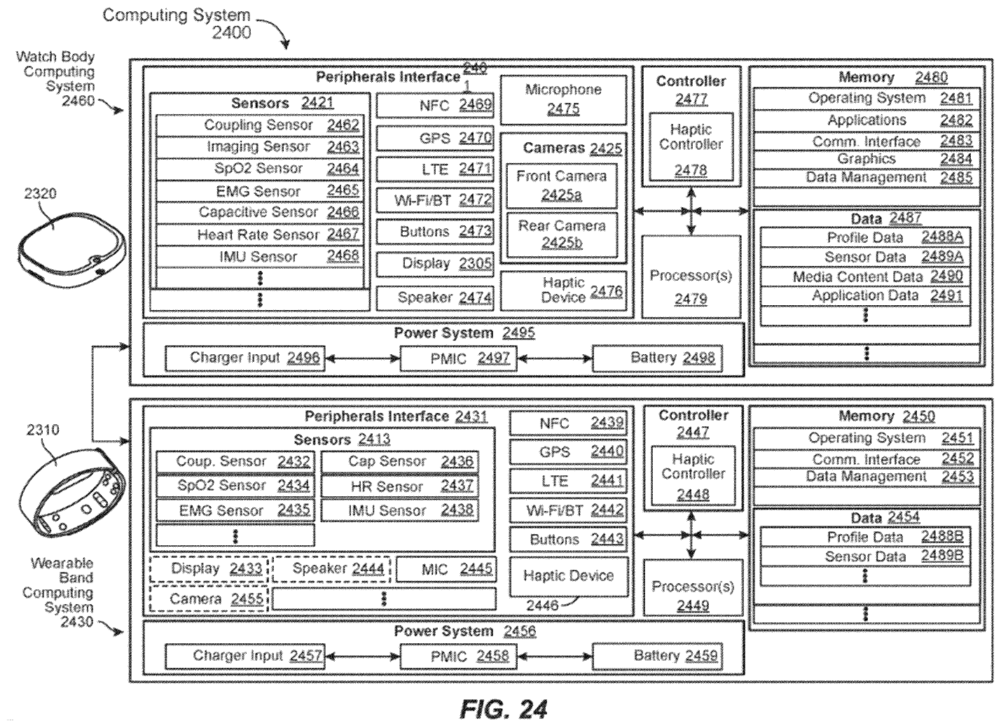

In some embodiments, peripherals interface 1850 can include one or more devices configured to be part of computing system 1840, many of which have been defined above and/or described with respect to wrist-wearable devices shown in FIGS. 23 and 24. For example, peripherals interface 1850 can include one or more sensors 1851. Some example sensors include: one or more pressure sensors 1852, one or more EMG sensors 1856, one or more IMU sensors 1858, one or more position sensors 1859, one or more capacitive sensors 1860, one or more force sensors 1861; and/or any other types of sensors defined above or described with respect to any other embodiments discussed herein.

In some embodiments, the peripherals interface can include one or more additional peripheral devices, including one or more Wi-Fi and/or Bluetooth devices 1868; one or more haptic assemblies 1862; one or more support structures 1863 (which can include one or more bladders 1864; one or more manifolds 1865; one or more pressure-changing devices 1867; and/or any other types of peripheral devices defined above or described with respect to any other embodiments discussed herein.

In some embodiments, each haptic assembly 1862 includes a support structure 1863 and at least one bladder 1864. Bladder 1864 (e.g., a membrane) may be a sealed, inflatable pocket made from a durable and puncture-resistant material, such as thermoplastic polyurethane (TPU), a flexible polymer, or the like. Bladder 1864 contains a medium (e.g., a fluid such as air, inert gas, or even a liquid) that can be added to or removed from bladder 1864 to change a pressure (e.g., fluid pressure) inside the bladder 1864. Support structure 1863 is made from a material that is stronger and stiffer than the material of bladder 1864. A respective support structure 1863 coupled to a respective bladder 1864 is configured to reinforce the respective bladder 1864 as the respective bladder 1864 changes shape and size due to changes in pressure (e.g., fluid pressure) inside the bladder.

The system 1840 also includes a haptic controller 1876 and a pressure-changing device 1867. In some embodiments, haptic controller 1876 is part of the computer system 1840 (e.g., in electronic communication with one or more processors 1877 of the computer system 1840). Haptic controller 1876 is configured to control operation of pressure-changing device 1867, and in turn operation of haptic device 1700. For example, haptic controller 1876 sends one or more signals to pressure-changing device 1867 to activate pressure-changing device 1867 (e.g., turn it on and off). The one or more signals may specify a desired pressure (e.g., pounds-per-square inch) to be output by pressure-changing device 1867. Generation of the one or more signals, and in turn the pressure output by pressure-changing device 1867, may be based on information collected by sensors 1851. For example, the one or more signals may cause pressure-changing device 1867 to increase the pressure (e.g., fluid pressure) inside a first haptic assembly 1862 at a first time, based on the information collected by sensors 1851 (e.g., the user makes contact with an artificial coffee mug or other artificial object). Then, the controller may send one or more additional signals to pressure-changing device 1867 that cause pressure-changing device 1867 to further increase the pressure inside first haptic assembly 1862 at a second time after the first time, based on additional information collected by sensors 1851. Further, the one or more signals may cause pressure-changing device 1867 to inflate one or more bladders 1864 in a first device 1700A, while one or more bladders 1864 in a second device 1700B remain unchanged. Additionally, the one or more signals may cause pressure-changing device 1867 to inflate one or more bladders 1864 in a first device 1700A to a first pressure and inflate one or more other bladders 1864 in first device 1700A to a second pressure different from the first pressure. Depending on number of devices 1700 serviced by pressure-changing device 1867, and the number of bladders therein, many different inflation configurations can be achieved through the one or more signals and the examples above are not meant to be limiting.

The system 1840 may include an optional manifold 1865 between pressure-changing device 1867 and haptic devices 1700. Manifold 1865 may include one or more valves (not shown) that pneumatically couple each of haptic assemblies 1862 with pressure-changing device 1867 via tubing. In some embodiments, manifold 1865 is in communication with controller 1875, and controller 1875 controls the one or more valves of manifold 1865 (e.g., the controller generates one or more control signals). Manifold 1865 is configured to switchably couple pressure-changing device 1867 with one or more haptic assemblies 1862 of the same or different haptic devices 1700 based on one or more control signals from controller 1875. In some embodiments, instead of using manifold 1865 to pneumatically couple pressure-changing device 1867 with haptic assemblies 1862, system 1840 may include multiple pressure-changing devices 1867, where each pressure-changing device 1867 is pneumatically coupled directly with a single haptic assembly 1862 or multiple haptic assemblies 1862. In some embodiments, pressure-changing device 1867 and optional manifold 1865 can be configured as part of one or more of the haptic devices 1700 while, in other embodiments, pressure-changing device 1867 and optional manifold 1865 can be configured as external to haptic device 1700. A single pressure-changing device 1867 may be shared by multiple haptic devices 1700.

In some embodiments, pressure-changing device 1867 is a pneumatic device, hydraulic device, a pneudraulic device, or some other device capable of adding and removing a medium (e.g., fluid, liquid, gas) from the one or more haptic assemblies 1862.

The devices shown in FIGS. 17A-18 may be coupled via a wired connection (e.g., via busing). Alternatively, one or more of the devices shown in FIGS. 17A-18 may be wirelessly connected (e.g., via short-range communication signals).

Memory 1878 includes instructions and data, some or all of which may be stored as non-transitory computer-readable storage media within memory 1878. For example, memory 1878 can include one or more operating systems 1879; one or more communication interface applications 1881; one or more interoperability modules 1884; one or more AR processing applications 1885; one or more data management modules 1886; and/or any other types of applications or modules defined above or described with respect to any other embodiments discussed herein.

Memory 1878 also includes data 1888 which can be used in conjunction with one or more of the applications discussed above. Data 1888 can include: device data 1890; sensor data 1891; and/or any other types of data defined above or described with respect to any other embodiments discussed herein.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed-or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

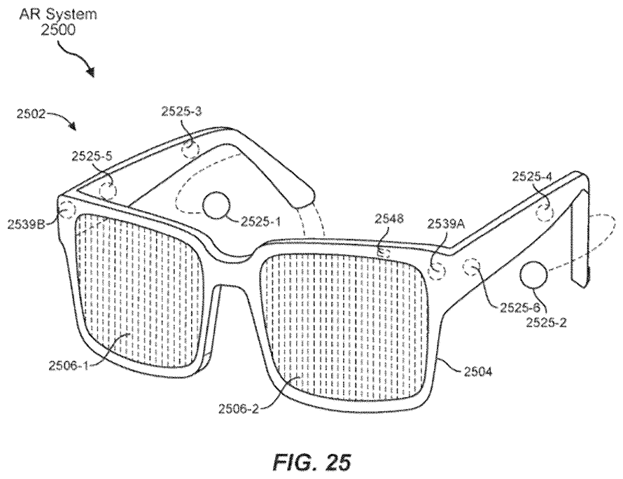

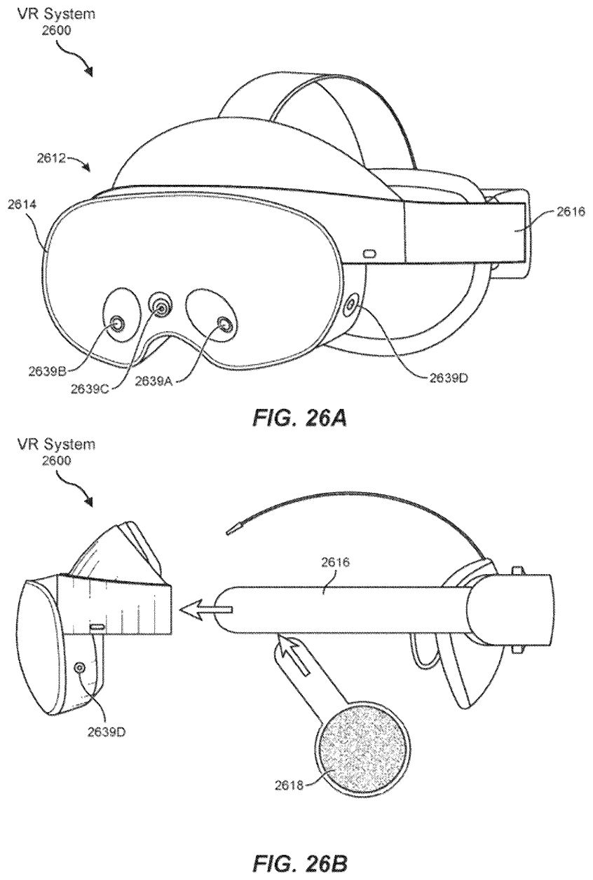

AR systems may be implemented in a variety of different form factors and configurations. Some AR systems may be designed to work without near-eye displays (NEDs). Other AR systems may include a NED that also provides visibility into the real world (such as, e.g., augmented-reality system 2500 in FIG. 25) or that visually immerses a user in an artificial reality (such as, e.g., virtual-reality system 2600 in FIGS. 26A and 26B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

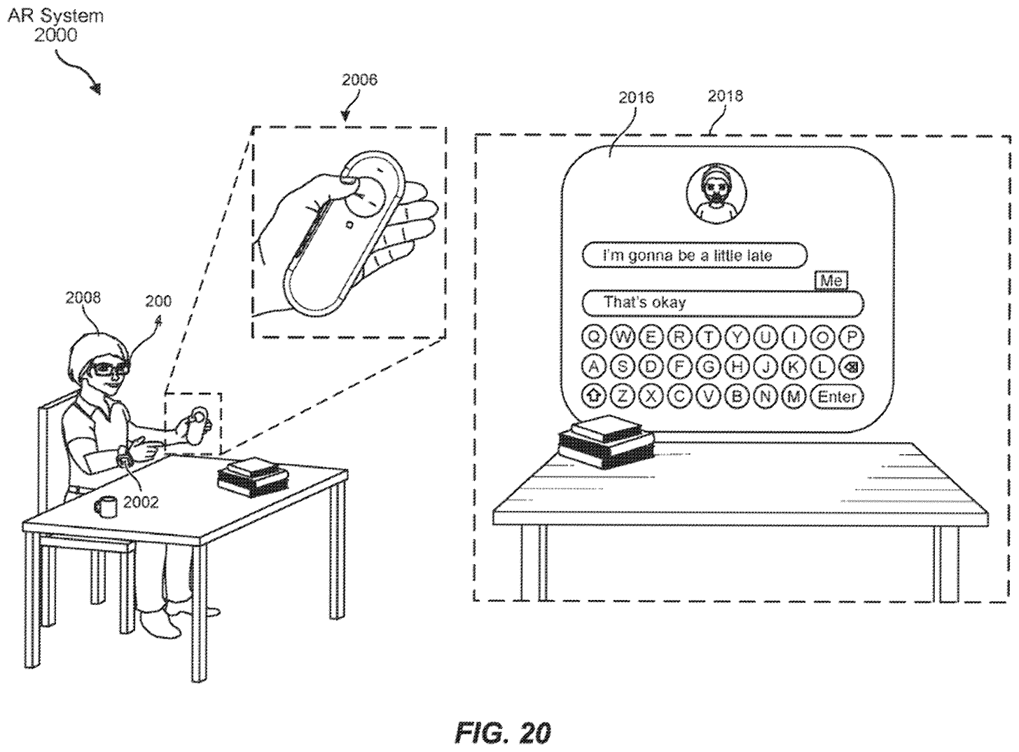

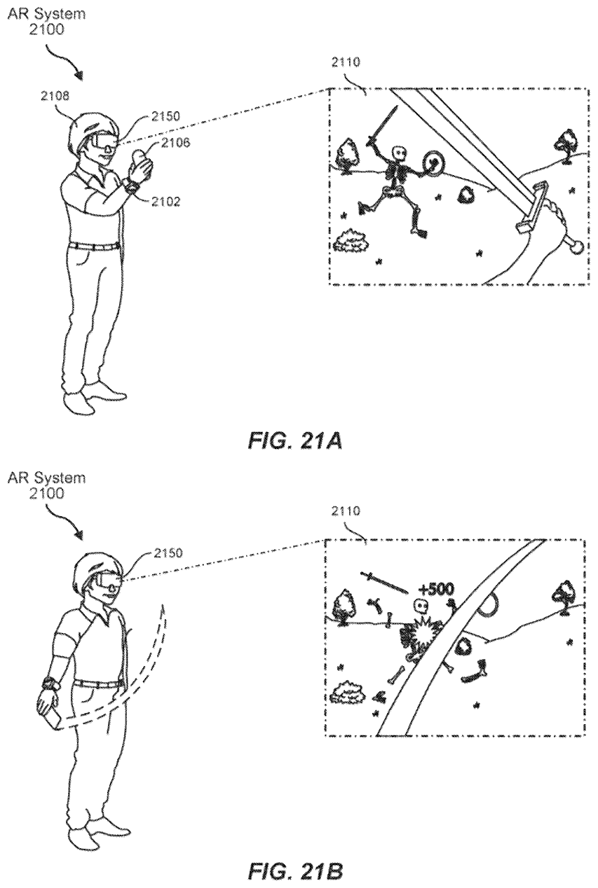

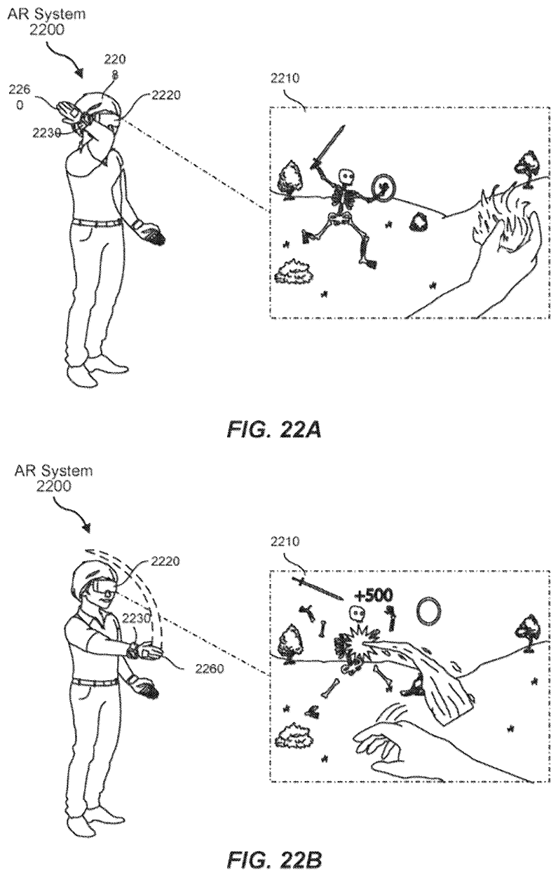

FIGS. 19-22B illustrate example artificial-reality (AR) systems in accordance with some embodiments. FIG. 19 shows a first AR system 1900 and first example user interactions using a wrist-wearable device 1902, a head-wearable device (e.g., AR glasses 2500), and/or a handheld intermediary processing device (HIPD) 1906. FIG. 20 shows a second AR system 2000 and second example user interactions using a wrist-wearable device 2002, AR glasses 2004, and/or an HIPD 2006. FIGS. 21A and 21B show a third AR system 2100 and third example user 2108 interactions using a wrist-wearable device 2102, a head-wearable device (e.g., VR headset 2150), and/or an HIPD 2106. FIGS. 22A and 22B show a fourth AR system 2200 and fourth example user 2208 interactions using a wrist-wearable device 2230, VR headset 2220, and/or a haptic device 2260 (e.g., wearable gloves).

A wrist-wearable device 2300, which can be used for wrist-wearable device 1902, 2002, 2102, 2230, and one or more of its components, are described below in reference to FIGS. 23 and 24; head-wearable devices 2500 and 2600, which can respectively be used for AR glasses 1904, 2004 or VR headset 2150, 2220, and their one or more components are described below in reference to FIGS. 25-27.

Referring to FIG. 19, wrist-wearable device 1902, AR glasses 1904, and/or HIPD 1906 can communicatively couple via a network 1925 (e.g., cellular, near field, Wi-Fi, personal area network, wireless LAN, etc.). Additionally, wrist-wearable device 1902, AR glasses 1904, and/or HIPD 1906 can also communicatively couple with one or more servers 1930, computers 1940 (e.g., laptops, computers, etc.), mobile devices 1950 (e.g., smartphones, tablets, etc.), and/or other electronic devices via network 1925 (e.g., cellular, near field, Wi-Fi, personal area network, wireless LAN, etc.).

In FIG. 19, a user 1908 is shown wearing wrist-wearable device 1902 and AR glasses 1904 and having HIPD 1906 on their desk. The wrist-wearable device 1902, AR glasses 1904, and HIPD 1906 facilitate user interaction with an AR environment. In particular, as shown by first AR system 1900, wrist-wearable device 1902, AR glasses 1904, and/or HIPD 1906 cause presentation of one or more avatars 1910, digital representations of contacts 1912, and virtual objects 1914. As discussed below, user 1908 can interact with one or more avatars 1910, digital representations of contacts 1912, and virtual objects 1914 via wrist-wearable device 1902, AR glasses 1904, and/or HIPD 1906.

User 1908 can use any of wrist-wearable device 1902, AR glasses 1904, and/or HIPD 1906 to provide user inputs. For example, user 1908 can perform one or more hand gestures that are detected by wrist-wearable device 1902 (e.g., using one or more EMG sensors and/or IMUs, described below in reference to FIGS. 23 and 24) and/or AR glasses 1904 (e.g., using one or more image sensor or camera, described below in reference to FIGS. 25-10) to provide a user input. Alternatively, or additionally, user 1908 can provide a user input via one or more touch surfaces of wrist-wearable device 1902, AR glasses 1904, HIPD 1906, and/or voice commands captured by a microphone of wrist-wearable device 1902, AR glasses 1904, and/or HIPD 1906. In some embodiments, wrist-wearable device 1902, AR glasses 1904, and/or HIPD 1906 include a digital assistant to help user 1908 in providing a user input (e.g., completing a sequence of operations, suggesting different operations or commands, providing reminders, confirming a command, etc.). In some embodiments, user 1908 can provide a user input via one or more facial gestures and/or facial expressions. For example, cameras of wrist-wearable device 1902, AR glasses 1904, and/or HIPD 1906 can track eyes of user 1908 for navigating a user interface.

Wrist-wearable device 1902, AR glasses 1904, and/or HIPD 1906 can operate alone or in conjunction to allow user 1908 to interact with the AR environment. In some embodiments, HIPD 1906 is configured to operate as a central hub or control center for the wrist-wearable device 1902, AR glasses 1904, and/or another communicatively coupled device. For example, user 1908 can provide an input to interact with the AR environment at any of wrist-wearable device 1902, AR glasses 1904, and/or HIPD 1906, and HIPD 1906 can identify one or more back-end and front-end tasks to cause the performance of the requested interaction and distribute instructions to cause the performance of the one or more back-end and front-end tasks at wrist-wearable device 1902, AR glasses 1904, and/or HIPD 1906. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). HIPD 1906 can perform the back-end tasks and provide wrist-wearable device 1902 and/or AR glasses 1904 operational data corresponding to the performed back-end tasks such that wrist-wearable device 1902 and/or AR glasses 1904 can perform the front-end tasks. In this way, HIPD 1906, which has more computational resources and greater thermal headroom than wrist-wearable device 1902 and/or AR glasses 1904, performs computationally intensive tasks and reduces the computer resource utilization and/or power usage of wrist-wearable device 1902 and/or AR glasses 1904.

In the example shown by first AR system 1900, HIPD 1906 identifies one or more back-end tasks and front-end tasks associated with a user request to initiate an AR video call with one or more other users (represented by avatar 1910 and the digital representation of contact 1912) and distributes instructions to cause the performance of the one or more back-end tasks and front-end tasks. In particular, HIPD 1906 performs back-end tasks for processing and/or rendering image data (and other data) associated with the AR video call and provides operational data associated with the performed back-end tasks to AR glasses 1904 such that the AR glasses 1904 perform front-end tasks for presenting the AR video call (e.g., presenting avatar 1910 and digital representation of contact 1912).

In some embodiments, HIPD 1906 can operate as a focal or anchor point for causing the presentation of information. This allows user 1908 to be generally aware of where information is presented. For example, as shown in first AR system 1900, avatar 1910 and the digital representation of contact 1912 are presented above HIPD 1906. In particular, HIPD 1906 and AR glasses 1904 operate in conjunction to determine a location for presenting avatar 1910 and the digital representation of contact 1912. In some embodiments, information can be presented a predetermined distance from HIPD 1906 (e.g., within 5 meters). For example, as shown in first AR system 1900, virtual object 1914 is presented on the desk some distance from HIPD 1906. Similar to the above example, HIPD 1906 and AR glasses 1904 can operate in conjunction to determine a location for presenting virtual object 1914. Alternatively, in some embodiments, presentation of information is not bound by HIPD 1906. More specifically, avatar 1910, digital representation of contact 1912, and virtual object 1914 do not have to be presented within a predetermined distance of HIPD 1906.

User inputs provided at wrist-wearable device 1902, AR glasses 1904, and/or HIPD 1906 are coordinated such that the user can use any device to initiate, continue, and/or complete an operation. For example, user 1908 can provide a user input to AR glasses 1904 to cause AR glasses 1904 to present virtual object 1914 and, while virtual object 1914 is presented by AR glasses 1904, user 1908 can provide one or more hand gestures via wrist-wearable device 1902 to interact and/or manipulate virtual object 1914.

FIG. 20 shows a user 2008 wearing a wrist-wearable device 2002 and AR glasses 2004, and holding an HIPD 2006. In second AR system 2000, the wrist-wearable device 2002, AR glasses 2004, and/or HIPD 2006 are used to receive and/or provide one or more messages to a contact of user 2008. In particular, wrist-wearable device 2002, AR glasses 2004, and/or HIPD 2006 detect and coordinate one or more user inputs to initiate a messaging application and prepare a response to a received message via the messaging application.

In some embodiments, user 2008 initiates, via a user input, an application on wrist-wearable device 2002, AR glasses 2004, and/or HIPD 2006 that causes the application to initiate on at least one device. For example, in second AR system 2000, user 2008 performs a hand gesture associated with a command for initiating a messaging application (represented by messaging user interface 2016), wrist-wearable device 2002 detects the hand gesture and, based on a determination that user 2008 is wearing AR glasses 2004, causes AR glasses 2004 to present a messaging user interface 2016 of the messaging application. AR glasses 2004 can present messaging user interface 2016 to user 2008 via its display (e.g., as shown by a field of view 2018 of user 2008). In some embodiments, the application is initiated and executed on the device (e.g., wrist-wearable device 2002, AR glasses 2004, and/or HIPD 2006) that detects the user input to initiate the application, and the device provides another device operational data to cause the presentation of the messaging application. For example, wrist-wearable device 2002 can detect the user input to initiate a messaging application, initiate and run the messaging application, and provide operational data to AR glasses 2004 and/or HIPD 2006 to cause presentation of the messaging application. Alternatively, the application can be initiated and executed at a device other than the device that detected the user input. For example, wrist-wearable device 2002 can detect the hand gesture associated with initiating the messaging application and cause HIPD 2006 to run the messaging application and coordinate the presentation of the messaging application.

Further, user 2008 can provide a user input provided at wrist-wearable device 2002, AR glasses 2004, and/or HIPD 2006 to continue and/or complete an operation initiated at another device. For example, after initiating the messaging application via wrist-wearable device 2002 and while AR glasses 2004 present messaging user interface 2016, user 2008 can provide an input at HIPD 2006 to prepare a response (e.g., shown by the swipe gesture performed on HIPD 2006). Gestures performed by user 2008 on HIPD 2006 can be provided and/or displayed on another device. For example, a swipe gestured performed on HIPD 2006 is displayed on a virtual keyboard of messaging user interface 2016 displayed by AR glasses 2004.

In some embodiments, wrist-wearable device 2002, AR glasses 2004, HIPD 2006, and/or any other communicatively coupled device can present one or more notifications to user 2008. The notification can be an indication of a new message, an incoming call, an application update, a status update, etc. User 2008 can select the notification via wrist-wearable device 2002, AR glasses 2004, and/or HIPD 2006 and can cause presentation of an application or operation associated with the notification on at least one device. For example, user 2008 can receive a notification that a message was received at wrist-wearable device 2002, AR glasses 2004, HIPD 2006, and/or any other communicatively coupled device and can then provide a user input at wrist-wearable device 2002, AR glasses 2004, and/or HIPD 2006 to review the notification, and the device detecting the user input can cause an application associated with the notification to be initiated and/or presented at wrist-wearable device 2002, AR glasses 2004, and/or HIPD 2006.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 2004 can present to user 2008 game application data, and HIPD 2006 can be used as a controller to provide inputs to the game. Similarly, user 2008 can use wrist-wearable device 2002 to initiate a camera of AR glasses 2004, and user 2008 can use wrist-wearable device 2002, AR glasses 2004, and/or HIPD 2006 to manipulate the image capture (e.g., zoom in or out, apply filters, etc.) and capture image data.

Users may interact with the devices disclosed herein in a variety of ways. For example, as shown in FIGS. 21A and 21B, a user 2108 may interact with an AR system 2100 by donning a VR headset 2150 while holding HIPD 2106 and wearing wrist-wearable device 2102. In this example, AR system 2100 may enable a user to interact with a game 2110 by swiping their arm. One or more of VR headset 2150, HIPD 2106, and wrist-wearable device 2102 may detect this gesture and, in response, may display a sword strike in game 2110. Similarly, in FIGS. 22A and 22B, a user 2208 may interact with an AR system 2200 by donning a VR headset 2220 while wearing haptic device 2260 and wrist-wearable device 2230. In this example, AR system 2200 may enable a user to interact with a game 2210 by swiping their arm. One or more of VR headset 2220, haptic device 2260, and wrist-wearable device 2230 may detect this gesture and, in response, may display a spell being cast in game 2110.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 2502.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 23 and 24 illustrate an example wrist-wearable device 2300 and an example computer system 2400, in accordance with some embodiments. Wrist-wearable device 2300 is an instance of wearable device 1902 described in FIG. 19 herein, such that the wearable device 1902 should be understood to have the features of the wrist-wearable device 2300 and vice versa. FIG. 24 illustrates components of the wrist-wearable device 2300, which can be used individually or in combination, including combinations that include other electronic devices and/or electronic components.

FIG. 23 shows a wearable band 2310 and a watch body 2320 (or capsule) being coupled, as discussed below, to form wrist-wearable device 2300. Wrist-wearable device 2300 can perform various functions and/or operations associated with navigating through user interfaces and selectively opening applications as well as the functions and/or operations described above with reference to FIGS. 19-22B.

As will be described in more detail below, operations executed by wrist-wearable device 2300 can include (i) presenting content to a user (e.g., displaying visual content via a display 2305), (ii) detecting (e.g., sensing) user input (e.g., sensing a touch on peripheral button 2323 and/or at a touch screen of the display 2305, a hand gesture detected by sensors (e.g., biopotential sensors)), (iii) sensing biometric data (e.g., neuromuscular signals, heart rate, temperature, sleep, etc.) via one or more sensors 2313, messaging (e.g., text, speech, video, etc.); image capture via one or more imaging devices or cameras 2325, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 2320, independently in wearable band 2310, and/or via an electronic communication between watch body 2320 and wearable band 2310. In some embodiments, functions can be executed on wrist-wearable device 2300 while an AR environment is being presented (e.g., via one of AR systems 1900 to 2200). The wearable devices described herein can also be used with other types of AR environments.

Wearable band 2310 can be configured to be worn by a user such that an inner surface of a wearable structure 2311 of wearable band 2310 is in contact with the user's skin. In this example, when worn by a user, sensors 2313 may contact the user's skin. In some examples, one or more of sensors 2313 can sense biometric data such as a user's heart rate, a saturated oxygen level, temperature, sweat level, neuromuscular signals, or a combination thereof. One or more of sensors 2313 can also sense data about a user's environment including a user's motion, altitude, location, orientation, gait, acceleration, position, or a combination thereof. In some embodiment, one or more of sensors 2313 can be configured to track a position and/or motion of wearable band 2310. One or more of sensors 2313 can include any of the sensors defined above and/or discussed below with respect to FIG. 23.

One or more of sensors 2313 can be distributed on an inside and/or an outside surface of wearable band 2310. In some embodiments, one or more of sensors 2313 are uniformly spaced along wearable band 2310. Alternatively, in some embodiments, one or more of sensors 2313 are positioned at distinct points along wearable band 2310. As shown in FIG. 23, one or more of sensors 2313 can be the same or distinct. For example, in some embodiments, one or more of sensors 2313 can be shaped as a pill (e.g., sensor 2313a), an oval, a circle a square, an oblong (e.g., sensor 2313c) and/or any other shape that maintains contact with the user's skin (e.g., such that neuromuscular signal and/or other biometric data can be accurately measured at the user's skin). In some embodiments, one or more sensors of 2313 are aligned to form pairs of sensors (e.g., for sensing neuromuscular signals based on differential sensing within each respective sensor). For example, sensor 2313b may be aligned with an adjacent sensor to form sensor pair 2314a and sensor 2313d may be aligned with an adjacent sensor to form sensor pair 2314b. In some embodiments, wearable band 2310 does not have a sensor pair. Alternatively, in some embodiments, wearable band 2310 has a predetermined number of sensor pairs (one pair of sensors, three pairs of sensors, four pairs of sensors, six pairs of sensors, sixteen pairs of sensors, etc.).

Wearable band 2310 can include any suitable number of sensors 2313. In some embodiments, the number and arrangement of sensors 2313 depends on the particular application for which wearable band 2310 is used. For instance, wearable band 2310 can be configured as an armband, wristband, or chest-band that include a plurality of sensors 2313 with different number of sensors 2313, a variety of types of individual sensors with the plurality of sensors 2313, and different arrangements for each use case, such as medical use cases as compared to gaming or general day-to-day use cases.

In accordance with some embodiments, wearable band 2310 further includes an electrical ground electrode and a shielding electrode. The electrical ground and shielding electrodes, like the sensors 2313, can be distributed on the inside surface of the wearable band 2310 such that they contact a portion of the user's skin. For example, the electrical ground and shielding electrodes can be at an inside surface of a coupling mechanism 2316 or an inside surface of a wearable structure 2311. The electrical ground and shielding electrodes can be formed and/or use the same components as sensors 2313. In some embodiments, wearable band 2310 includes more than one electrical ground electrode and more than one shielding electrode.

Sensors 2313 can be formed as part of wearable structure 2311 of wearable band 2310. In some embodiments, sensors 2313 are flush or substantially flush with wearable structure 2311 such that they do not extend beyond the surface of wearable structure 2311. While flush with wearable structure 2311, sensors 2313 are still configured to contact the user's skin (e.g., via a skin-contacting surface). Alternatively, in some embodiments, sensors 2313 extend beyond wearable structure 2311 a predetermined distance (e.g., 0.1-2 mm) to make contact and depress into the user's skin. In some embodiment, sensors 2313 are coupled to an actuator (not shown) configured to adjust an extension height (e.g., a distance from the surface of wearable structure 2311) of sensors 2313 such that sensors 2313 make contact and depress into the user's skin. In some embodiments, the actuators adjust the extension height between 0.01 mm-1.2 mm. This may allow the user to customize the positioning of sensors 2313 to improve the overall comfort of the wearable band 2310 when worn while still allowing sensors 2313 to contact the user's skin. In some embodiments, sensors 2313 are indistinguishable from wearable structure 2311 when worn by the user.

Wearable structure 2311 can be formed of an elastic material, elastomers, etc., configured to be stretched and fitted to be worn by the user. In some embodiments, wearable structure 2311 is a textile or woven fabric. As described above, sensors 2313 can be formed as part of a wearable structure 2311. For example, sensors 2313 can be molded into the wearable structure 2311, be integrated into a woven fabric (e.g., sensors 2313 can be sewn into the fabric and mimic the pliability of fabric and can and/or be constructed from a series woven strands of fabric).

Wearable structure 2311 can include flexible electronic connectors that interconnect sensors 2313, the electronic circuitry, and/or other electronic components (described below in reference to FIG. 24) that are enclosed in wearable band 2310. In some embodiments, the flexible electronic connectors are configured to interconnect sensors 2313, the electronic circuitry, and/or other electronic components of wearable band 2310 with respective sensors and/or other electronic components of another electronic device (e.g., watch body 2320). The flexible electronic connectors are configured to move with wearable structure 2311 such that the user adjustment to wearable structure 2311 (e.g., resizing, pulling, folding, etc.) does not stress or strain the electrical coupling of components of wearable band 2310.

As described above, wearable band 2310 is configured to be worn by a user. In particular, wearable band 2310 can be shaped or otherwise manipulated to be worn by a user. For example, wearable band 2310 can be shaped to have a substantially circular shape such that it can be configured to be worn on the user's lower arm or wrist. Alternatively, wearable band 2310 can be shaped to be worn on another body part of the user, such as the user's upper arm (e.g., around a bicep), forearm, chest, legs, etc. Wearable band 2310 can include a retaining mechanism 2312 (e.g., a buckle, a hook and loop fastener, etc.) for securing wearable band 2310 to the user's wrist or other body part. While wearable band 2310 is worn by the user, sensors 2313 sense data (referred to as sensor data) from the user's skin. In some examples, sensors 2313 of wearable band 2310 obtain (e.g., sense and record) neuromuscular signals.

The sensed data (e.g., sensed neuromuscular signals) can be used to detect and/or determine the user's intention to perform certain motor actions. In some examples, sensors 2313 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 2305 of wrist-wearable device 2300 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 2313 can be used to provide a user with an enhanced interaction with a physical object (e.g., devices communicatively coupled with wearable band 2310) and/or a virtual object in an artificial-reality application generated by an artificial-reality system (e.g., user interface objects presented on the display 2305, or another computing device (e.g., a smartphone)).

In some embodiments, wearable band 2310 includes one or more haptic devices 2446 (e.g., a vibratory haptic actuator) that are configured to provide haptic feedback (e.g., a cutaneous and/or kinesthetic sensation, etc.) to the user's skin. Sensors 2313 and/or haptic devices 2446 (shown in FIG. 24) can be configured to operate in conjunction with multiple applications including, without limitation, health monitoring, social media, games, and artificial reality (e.g., the applications associated with artificial reality).

Wearable band 2310 can also include coupling mechanism 2316 for detachably coupling a capsule (e.g., a computing unit) or watch body 2320 (via a coupling surface of the watch body 2320) to wearable band 2310. For example, a cradle or a shape of coupling mechanism 2316 can correspond to shape of watch body 2320 of wrist-wearable device 2300. In particular, coupling mechanism 2316 can be configured to receive a coupling surface proximate to the bottom side of watch body 2320 (e.g., a side opposite to a front side of watch body 2320 where display 2305 is located), such that a user can push watch body 2320 downward into coupling mechanism 2316 to attach watch body 2320 to coupling mechanism 2316. In some embodiments, coupling mechanism 2316 can be configured to receive a top side of the watch body 2320 (e.g., a side proximate to the front side of watch body 2320 where display 2305 is located) that is pushed upward into the cradle, as opposed to being pushed downward into coupling mechanism 2316. In some embodiments, coupling mechanism 2316 is an integrated component of wearable band 2310 such that wearable band 2310 and coupling mechanism 2316 are a single unitary structure. In some embodiments, coupling mechanism 2316 is a type of frame or shell that allows watch body 2320 coupling surface to be retained within or on wearable band 2310 coupling mechanism 2316 (e.g., a cradle, a tracker band, a support base, a clasp, etc.).

Coupling mechanism 2316 can allow for watch body 2320 to be detachably coupled to the wearable band 2310 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 2320 to wearable band 2310 and to decouple the watch body 2320 from the wearable band 2310. For example, a user can twist, slide, turn, push, pull, or rotate watch body 2320 relative to wearable band 2310, or a combination thereof, to attach watch body 2320 to wearable band 2310 and to detach watch body 2320 from wearable band 2310. Alternatively, as discussed below, in some embodiments, the watch body 2320 can be decoupled from the wearable band 2310 by actuation of a release mechanism 2329.

Wearable band 2310 can be coupled with watch body 2320 to increase the functionality of wearable band 2310 (e.g., converting wearable band 2310 into wrist-wearable device 2300, adding an additional computing unit and/or battery to increase computational resources and/or a battery life of wearable band 2310, adding additional sensors to improve sensed data, etc.). As described above, wearable band 2310 and coupling mechanism 2316 are configured to operate independently (e.g., execute functions independently) from watch body 2320. For example, coupling mechanism 2316 can include one or more sensors 2313 that contact a user's skin when wearable band 2310 is worn by the user, with or without watch body 2320 and can provide sensor data for determining control commands.

A user can detach watch body 2320 from wearable band 2310 to reduce the encumbrance of wrist-wearable device 2300 to the user. For embodiments in which watch body 2320 is removable, watch body 2320 can be referred to as a removable structure, such that in these embodiments wrist-wearable device 2300 includes a wearable portion (e.g., wearable band 2310) and a removable structure (e.g., watch body 2320).

Turning to watch body 2320, in some examples watch body 2320 can have a substantially rectangular or circular shape. Watch body 2320 is configured to be worn by the user on their wrist or on another body part. More specifically, watch body 2320 is sized to be easily carried by the user, attached on a portion of the user's clothing, and/or coupled to wearable band 2310 (forming the wrist-wearable device 2300). As described above, watch body 2320 can have a shape corresponding to coupling mechanism 2316 of wearable band 2310. In some embodiments, watch body 2320 includes a single release mechanism 2329 or multiple release mechanisms (e.g., two release mechanisms 2329 positioned on opposing sides of watch body 2320, such as spring-loaded buttons) for decoupling watch body 2320 from wearable band 2310. Release mechanism 2329 can include, without limitation, a button, a knob, a plunger, a handle, a lever, a fastener, a clasp, a dial, a latch, or a combination thereof.

A user can actuate release mechanism 2329 by pushing, turning, lifting, depressing, shifting, or performing other actions on release mechanism 2329. Actuation of release mechanism 2329 can release (e.g., decouple) watch body 2320 from coupling mechanism 2316 of wearable band 2310, allowing the user to use watch body 2320 independently from wearable band 2310 and vice versa. For example, decoupling watch body 2320 from wearable band 2310 can allow a user to capture images using rear-facing camera 2325b. Although release mechanism 2329 is shown positioned at a corner of watch body 2320, release mechanism 2329 can be positioned anywhere on watch body 2320 that is convenient for the user to actuate. In addition, in some embodiments, wearable band 2310 can also include a respective release mechanism for decoupling watch body 2320 from coupling mechanism 2316. In some embodiments, release mechanism 2329 is optional and watch body 2320 can be decoupled from coupling mechanism 2316 as described above (e.g., via twisting, rotating, etc.).

Watch body 2320 can include one or more peripheral buttons 2323 and 2327 for performing various operations at watch body 2320. For example, peripheral buttons 2323 and 2327 can be used to turn on or wake (e.g., transition from a sleep state to an active state) display 2305, unlock watch body 2320, increase or decrease a volume, increase or decrease a brightness, interact with one or more applications, interact with one or more user interfaces, etc. Additionally or alternatively, in some embodiments, display 2305 operates as a touch screen and allows the user to provide one or more inputs for interacting with watch body 2320.

In some embodiments, watch body 2320 includes one or more sensors 2321. Sensors 2321 of watch body 2320 can be the same or distinct from sensors 2313 of wearable band 2310. Sensors 2321 of watch body 2320 can be distributed on an inside and/or an outside surface of watch body 2320. In some embodiments, sensors 2321 are configured to contact a user's skin when watch body 2320 is worn by the user. For example, sensors 2321 can be placed on the bottom side of watch body 2320 and coupling mechanism 2316 can be a cradle with an opening that allows the bottom side of watch body 2320 to directly contact the user's skin. Alternatively, in some embodiments, watch body 2320 does not include sensors that are configured to contact the user's skin (e.g., including sensors internal and/or external to the watch body 2320 that are configured to sense data of watch body 2320 and the surrounding environment). In some embodiments, sensors 2321 are configured to track a position and/or motion of watch body 2320.

Watch body 2320 and wearable band 2310 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 2320 and wearable band 2310 can share data sensed by sensors 2313 and 2321, as well as application and device specific information (e.g., active and/or available applications, output devices (e.g., displays, speakers, etc.), input devices (e.g., touch screens, microphones, imaging sensors, etc.).

In some embodiments, watch body 2320 can include, without limitation, a front-facing camera 2325a and/or a rear-facing camera 2325b, sensors 2321 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 2463), a touch sensor, a sweat sensor, etc.). In some embodiments, watch body 2320 can include one or more haptic devices 2476 (e.g., a vibratory haptic actuator) that is configured to provide haptic feedback (e.g., a cutaneous and/or kinesthetic sensation, etc.) to the user. Sensors 2421 and/or haptic device 2476 can also be configured to operate in conjunction with multiple applications including, without limitation, health monitoring applications, social media applications, game applications, and artificial reality applications (e.g., the applications associated with artificial reality).

As described above, watch body 2320 and wearable band 2310, when coupled, can form wrist-wearable device 2300. When coupled, watch body 2320 and wearable band 2310 may operate as a single device to execute functions (operations, detections, communications, etc.) described herein. In some embodiments, each device may be provided with particular instructions for performing the one or more operations of wrist-wearable device 2300. For example, in accordance with a determination that watch body 2320 does not include neuromuscular signal sensors, wearable band 2310 can include alternative instructions for performing associated instructions (e.g., providing sensed neuromuscular signal data to watch body 2320 via a different electronic device). Operations of wrist-wearable device 2300 can be performed by watch body 2320 alone or in conjunction with wearable band 2310 (e.g., via respective processors and/or hardware components) and vice versa. In some embodiments, operations of wrist-wearable device 2300, watch body 2320, and/or wearable band 2310 can be performed in conjunction with one or more processors and/or hardware components.

As described below with reference to the block diagram of FIG. 24, wearable band 2310 and/or watch body 2320 can each include independent resources required to independently execute functions. For example, wearable band 2310 and/or watch body 2320 can each include a power source (e.g., a battery), a memory, data storage, a processor (e.g., a central processing unit (CPU)), communications, a light source, and/or input/output devices.

FIG. 24 shows block diagrams of a computing system 2430 corresponding to wearable band 2310 and a computing system 2460 corresponding to watch body 2320 according to some embodiments. Computing system 2400 of wrist-wearable device 2300 may include a combination of components of wearable band computing system 2430 and watch body computing system 2460, in accordance with some embodiments.

Watch body 2320 and/or wearable band 2310 can include one or more components shown in watch body computing system 2460. In some embodiments, a single integrated circuit may include all or a substantial portion of the components of watch body computing system 2460 included in a single integrated circuit. Alternatively, in some embodiments, components of the watch body computing system 2460 may be included in a plurality of integrated circuits that are communicatively coupled. In some embodiments, watch body computing system 2460 may be configured to couple (e.g., via a wired or wireless connection) with wearable band computing system 2430, which may allow the computing systems to share components, distribute tasks, and/or perform other operations described herein (individually or as a single device).

Watch body computing system 2460 can include one or more processors 2479, a controller 2477, a peripherals interface 2461, a power system 2495, and memory (e.g., a memory 2480).

Power system 2495 can include a charger input 2496, a power-management integrated circuit (PMIC) 2497, and a battery 2498. In some embodiments, a watch body 2320 and a wearable band 2310 can have respective batteries (e.g., battery 2498 and 2459) and can share power with each other. Watch body 2320 and wearable band 2310 can receive a charge using a variety of techniques. In some embodiments, watch body 2320 and wearable band 2310 can use a wired charging assembly (e.g., power cords) to receive the charge. Alternatively, or in addition, watch body 2320 and/or wearable band 2310 can be configured for wireless charging. For example, a portable charging device can be designed to mate with a portion of watch body 2320 and/or wearable band 2310 and wirelessly deliver usable power to battery 2498 of watch body 2320 and/or battery 2459 of wearable band 2310. Watch body 2320 and wearable band 2310 can have independent power systems (e.g., power system 2495 and 2456, respectively) to enable each to operate independently. Watch body 2320 and wearable band 2310 can also share power (e.g., one can charge the other) via respective PMICs (e.g., PMICs 2497 and 2458) and charger inputs (e.g., 2457 and 2496) that can share power over power and ground conductors and/or over wireless charging antennas.

In some embodiments, peripherals interface 2461 can include one or more sensors 2421. Sensors 2421 can include one or more coupling sensors 2462 for detecting when watch body 2320 is coupled with another electronic device (e.g., a wearable band 2310). Sensors 2421 can include one or more imaging sensors 2463 (e.g., one or more of cameras 2425, and/or separate imaging sensors 2463 (e.g., thermal-imaging sensors)). In some embodiments, sensors 2421 can include one or more SpO2 sensors 2464. In some embodiments, sensors 2421 can include one or more biopotential-signal sensors (e.g., EMG sensors 2465, which may be disposed on an interior, user-facing portion of watch body 2320 and/or wearable band 2310). In some embodiments, sensors 2421 may include one or more capacitive sensors 2466. In some embodiments, sensors 2421 may include one or more heart rate sensors 2467. In some embodiments, sensors 2421 may include one or more IMU sensors 2468. In some embodiments, one or more IMU sensors 2468 can be configured to detect movement of a user's hand or other location where watch body 2320 is placed or held.

In some embodiments, one or more of sensors 2421 may provide an example human-machine interface. For example, a set of neuromuscular sensors, such as EMG sensors 2465, may be arranged circumferentially around wearable band 2310 with an interior surface of EMG sensors 2465 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 2310 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 2479. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 2465 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 2461 includes a near-field communication (NFC) component 2469, a global-position system (GPS) component 2470, a long-term evolution (LTE) component 2471, and/or a Wi-Fi and/or Bluetooth communication component 2472. In some embodiments, peripherals interface 2461 includes one or more buttons 2473 (e.g., peripheral buttons 2323 and 2327 in FIG. 23), which, when selected by a user, cause operation to be performed at watch body 2320. In some embodiments, the peripherals interface 2461 includes one or more indicators, such as a light emitting diode (LED), to provide a user with visual indicators (e.g., message received, low battery, active microphone and/or camera, etc.).

Watch body 2320 can include at least one display 2305 for displaying visual representations of information or data to a user, including user-interface elements and/or three-dimensional virtual objects. The display can also include a touch screen for inputting user inputs, such as touch gestures, swipe gestures, and the like. Watch body 2320 can include at least one speaker 2474 and at least one microphone 2475 for providing audio signals to the user and receiving audio input from the user. The user can provide user inputs through microphone 2475 and can also receive audio output from speaker 2474 as part of a haptic event provided by haptic controller 2478. Watch body 2320 can include at least one camera 2425, including a front camera 2425a and a rear camera 2425b. Cameras 2425 can include ultra-wide-angle cameras, wide angle cameras, fish-eye cameras, spherical cameras, telephoto cameras, depth-sensing cameras, or other types of cameras.

Watch body computing system 2460 can include one or more haptic controllers 2478 and associated componentry (e.g., haptic devices 2476) for providing haptic events at watch body 2320 (e.g., a vibrating sensation or audio output in response to an event at the watch body 2320). Haptic controllers 2478 can communicate with one or more haptic devices 2476, such as electroacoustic devices, including a speaker of the one or more speakers 2474 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 2478 can provide haptic events to that are capable of being sensed by a user of watch body 2320. In some embodiments, one or more haptic controllers 2478 can receive input signals from an application of applications 2482.

In some embodiments, wearable band computing system 2430 and/or watch body computing system 2460 can include memory 2480, which can be controlled by one or more memory controllers of controllers 2477. In some embodiments, software components stored in memory 2480 include one or more applications 2482 configured to perform operations at the watch body 2320. In some embodiments, one or more applications 2482 may include games, word processors, messaging applications, calling applications, web browsers, social media applications, media streaming applications, financial applications, calendars, clocks, etc. In some embodiments, software components stored in memory 2480 include one or more communication interface modules 2483 as defined above. In some embodiments, software components stored in memory 2480 include one or more graphics modules 2484 for rendering, encoding, and/or decoding audio and/or visual data and one or more data management modules 2485 for collecting, organizing, and/or providing access to data 2487 stored in memory 2480. In some embodiments, one or more of applications 2482 and/or one or more modules can work in conjunction with one another to perform various tasks at the watch body 2320.

In some embodiments, software components stored in memory 2480 can include one or more operating systems 2481 (e.g., a Linux-based operating system, an Android operating system, etc.). Memory 2480 can also include data 2487. Data 2487 can include profile data 2488A, sensor data 2489A, media content data 2490, and application data 2491.

It should be appreciated that watch body computing system 2460 is an example of a computing system within watch body 2320, and that watch body 2320 can have more or fewer components than shown in watch body computing system 2460, can combine two or more components, and/or can have a different configuration and/or arrangement of the components. The various components shown in watch body computing system 2460 are implemented in hardware, software, firmware, or a combination thereof, including one or more signal processing and/or application-specific integrated circuits.

Turning to the wearable band computing system 2430, one or more components that can be included in wearable band 2310 are shown. Wearable band computing system 2430 can include more or fewer components than shown in watch body computing system 2460, can combine two or more components, and/or can have a different configuration and/or arrangement of some or all of the components. In some embodiments, all, or a substantial portion of the components of wearable band computing system 2430 are included in a single integrated circuit. Alternatively, in some embodiments, components of wearable band computing system 2430 are included in a plurality of integrated circuits that are communicatively coupled. As described above, in some embodiments, wearable band computing system 2430 is configured to couple (e.g., via a wired or wireless connection) with watch body computing system 2460, which allows the computing systems to share components, distribute tasks, and/or perform other operations described herein (individually or as a single device).

Wearable band computing system 2430, similar to watch body computing system 2460, can include one or more processors 2449, one or more controllers 2447 (including one or more haptics controllers 2448), a peripherals interface 2431 that can includes one or more sensors 2413 and other peripheral devices, a power source (e.g., a power system 2456), and memory (e.g., a memory 2450) that includes an operating system (e.g., an operating system 2451), data (e.g., data 2454 including profile data 2488B, sensor data 2489B, etc.), and one or more modules (e.g., a communications interface module 2452, a data management module 2453, etc.).

One or more of sensors 2413 can be analogous to sensors 2421 of watch body computing system 2460. For example, sensors 2413 can include one or more coupling sensors 2432, one or more SpO2 sensors 2434, one or more EMG sensors 2435, one or more capacitive sensors 2436, one or more heart rate sensors 2437, and one or more IMU sensors 2438.

Peripherals interface 2431 can also include other components analogous to those included in peripherals interface 2461 of watch body computing system 2460, including an NFC component 2439, a GPS component 2440, an LTE component 2441, a Wi-Fi and/or Bluetooth communication component 2442, and/or one or more haptic devices 2446 as described above in reference to peripherals interface 2461. In some embodiments, peripherals interface 2431 includes one or more buttons 2443, a display 2433, a speaker 2444, a microphone 2445, and a camera 2455. In some embodiments, peripherals interface 2431 includes one or more indicators, such as an LED.

It should be appreciated that wearable band computing system 2430 is an example of a computing system within wearable band 2310, and that wearable band 2310 can have more or fewer components than shown in wearable band computing system 2430, combine two or more components, and/or have a different configuration and/or arrangement of the components. The various components shown in wearable band computing system 2430 can be implemented in one or more of a combination of hardware, software, or firmware, including one or more signal processing and/or application-specific integrated circuits.

Wrist-wearable device 2300 with respect to FIG. 23 is an example of wearable band 2310 and watch body 2320 coupled together, so wrist-wearable device 2300 will be understood to include the components shown and described for wearable band computing system 2430 and watch body computing system 2460. In some embodiments, wrist-wearable device 2300 has a split architecture (e.g., a split mechanical architecture, a split electrical architecture, etc.) between watch body 2320 and wearable band 2310. In other words, all of the components shown in wearable band computing system 2430 and watch body computing system 2460 can be housed or otherwise disposed in a combined wrist-wearable device 2300 or within individual components of watch body 2320, wearable band 2310, and/or portions thereof (e.g., a coupling mechanism 2316 of wearable band 2310).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 2300 can be used in conjunction with a head-wearable device (e.g., AR glasses 2500 and VR system 2610). As described below, and wrist-wearable device 2300 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 2500 and VR system 2610.

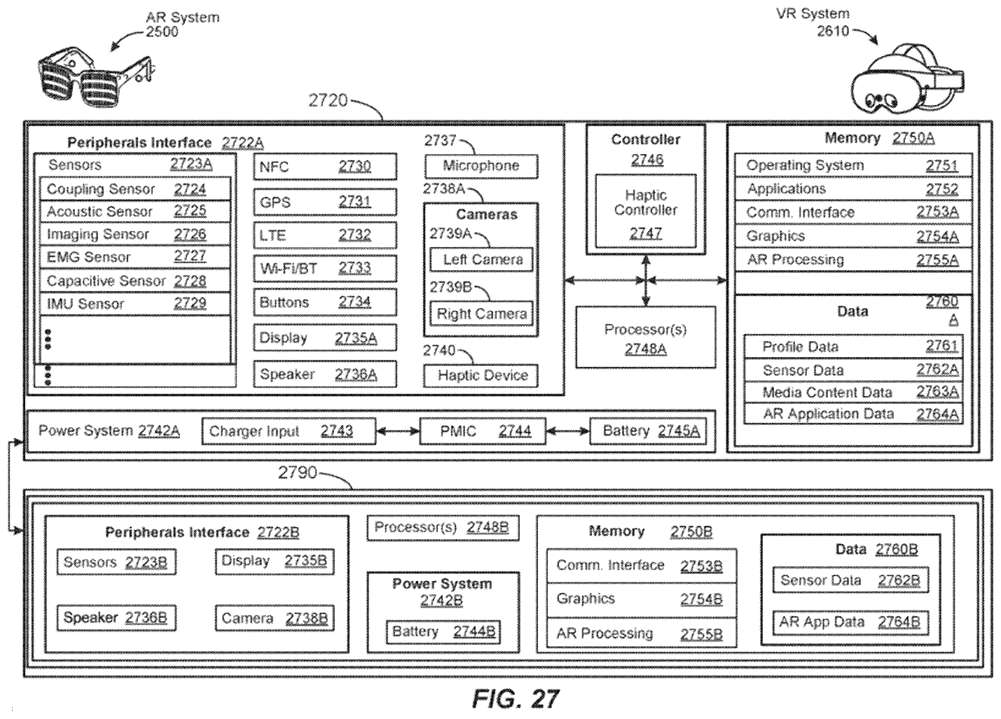

FIGS. 25 to 27 show example artificial-reality systems, which can be used as or in connection with wrist-wearable device 2300. In some embodiments, AR system 2500 includes an eyewear device 2502, as shown in FIG. 25. In some embodiments, VR system 2610 includes a head-mounted display (HMD) 2612, as shown in FIGS. 26A and 26B. In some embodiments, AR system 2500 and VR system 2610 can include one or more analogous components (e.g., components for presenting interactive artificial-reality environments, such as processors, memory, and/or presentation devices, including one or more displays and/or one or more waveguides), some of which are described in more detail with respect to FIG. 27. As described herein, a head-wearable device can include components of eyewear device 2502 and/or HMD 2612. Some embodiments of head-wearable devices do not include any displays, including any of the displays described with respect to AR system 2500 and/or VR system 2610. While the example artificial-reality systems are respectively described herein as AR system 2500 and VR system 2610, either or both of the example AR systems described herein can be configured to present fully-immersive virtual-reality scenes presented in substantially all of a user's field of view or subtler augmented-reality scenes that are presented within a portion, less than all, of the user's field of view.

FIG. 25 show an example visual depiction of AR system 2500, including an eyewear device 2502 (which may also be described herein as augmented-reality glasses, and/or smart glasses). AR system 2500 can include additional electronic components that are not shown in FIG. 25, such as a wearable accessory device and/or an intermediary processing device, in electronic communication or otherwise configured to be used in conjunction with the eyewear device 2502. In some embodiments, the wearable accessory device and/or the intermediary processing device may be configured to couple with eyewear device 2502 via a coupling mechanism in electronic communication with a coupling sensor 2724 (FIG. 27), where coupling sensor 2724 can detect when an electronic device becomes physically or electronically coupled with eyewear device 2502. In some embodiments, eyewear device 2502 can be configured to couple to a housing 2790 (FIG. 27), which may include one or more additional coupling mechanisms configured to couple with additional accessory devices. The components shown in FIG. 25 can be implemented in hardware, software, firmware, or a combination thereof, including one or more signal-processing components and/or application-specific integrated circuits (ASICs).

Eyewear device 2502 includes mechanical glasses components, including a frame 2504 configured to hold one or more lenses (e.g., one or both lenses 2506-1 and 2506-2). One of ordinary skill in the art will appreciate that eyewear device 2502 can include additional mechanical components, such as hinges configured to allow portions of frame 2504 of eyewear device 2502 to be folded and unfolded, a bridge configured to span the gap between lenses 2506-1 and 2506-2 and rest on the user's nose, nose pads configured to rest on the bridge of the nose and provide support for eyewear device 2502, earpieces configured to rest on the user's ears and provide additional support for eyewear device 2502, temple arms configured to extend from the hinges to the earpieces of eyewear device 2502, and the like. One of ordinary skill in the art will further appreciate that some examples of AR system 2500 can include none of the mechanical components described herein. For example, smart contact lenses configured to present artificial reality to users may not include any components of eyewear device 2502.

Eyewear device 2502 includes electronic components, many of which will be described in more detail below with respect to FIG. 25. Some example electronic components are illustrated in FIG. 25, including acoustic sensors 2525-1, 2525-2, 2525-3, 2525-4, 2525-5, and 2525-6, which can be distributed along a substantial portion of the frame 2504 of eyewear device 2502. Eyewear device 2502 also includes a left camera 2539A and a right camera 2539B, which are located on different sides of the frame 2504. Eyewear device 2502 also includes a processor 2548 (or any other suitable type or form of integrated circuit) that is embedded into a portion of the frame 2504.

FIGS. 26A and 26B show a VR system 2610 that includes a head-mounted display (HMD) 2612 (e.g., also referred to herein as an artificial-reality headset, a head-wearable device, a VR system, etc.), in accordance with some embodiments. As noted, some artificial-reality systems (e.g., AR system 2500) may, instead of blending an artificial reality with actual reality, substantially replace one or more of a user's visual and/or other sensory perceptions of the real world with a virtual experience (e.g., AR systems 2100 and 2200).

HMD 2612 includes a front body 2614 and a frame 2616 (e.g., a strap or band) shaped to fit around a user's head. In some embodiments, front body 2614 and/or frame 2616 include one or more electronic elements for facilitating presentation of and/or interactions with an AR and/or VR system (e.g., displays, IMUs, tracking emitter or detectors). In some embodiments, HMD 2612 includes output audio transducers (e.g., an audio transducer 2618), as shown in FIG. 26B. In some embodiments, one or more components, such as the output audio transducer(s) 2618 and frame 2616, can be configured to attach and detach (e.g., are detachably attachable) to HMD 2612 (e.g., a portion or all of frame 2616, and/or audio transducer 2618), as shown in FIG. 26B. In some embodiments, coupling a detachable component to HMD 2612 causes the detachable component to come into electronic communication with HMD 2612.

FIGS. 26A and 26B also show that VR system 2610 includes one or more cameras, such as left camera 2639A and right camera 2639B, which can be analogous to left and right cameras 2539A and 2539B on frame 2504 of eyewear device 2502. In some embodiments, VR system 2610 includes one or more additional cameras (e.g., cameras 2639C and 2639D), which can be configured to augment image data obtained by left and right cameras 2639A and 2639B by providing more information. For example, camera 2639C can be used to supply color information that is not discerned by cameras 2639A and 2639B. In some embodiments, one or more of cameras 2639A to 2639D can include an optional IR cut filter configured to remove IR light from being received at the respective camera sensors.

FIG. 27 illustrates a computing system 2720 and an optional housing 2790, each of which show components that can be included in AR system 2500 and/or VR system 2610. In some embodiments, more or fewer components can be included in optional housing 2790 depending on practical restraints of the respective AR system being described.

In some embodiments, computing system 2720 can include one or more peripherals interfaces 2722A and/or optional housing 2790 can include one or more peripherals interfaces 2722B. Each of computing system 2720 and optional housing 2790 can also include one or more power systems 2742A and 2742B, one or more controllers 2746 (including one or more haptic controllers 2747), one or more processors 2748A and 2748B (as defined above, including any of the examples provided), and memory 2750A and 2750B, which can all be in electronic communication with each other. For example, the one or more processors 2748A and 2748B can be configured to execute instructions stored in memory 2750A and 2750B, which can cause a controller of one or more of controllers 2746 to cause operations to be performed at one or more peripheral devices connected to peripherals interface 2722A and/or 2722B. In some embodiments, each operation described can be powered by electrical power provided by power system 2742A and/or 2742B.

In some embodiments, peripherals interface 2722A can include one or more devices configured to be part of computing system 2720, some of which have been defined above and/or described with respect to the wrist-wearable devices shown in FIGS. 23 and 24. For example, peripherals interface 2722A can include one or more sensors 2723A. Some example sensors 2723A include one or more coupling sensors 2724, one or more acoustic sensors 2725, one or more imaging sensors 2726, one or more EMG sensors 2727, one or more capacitive sensors 2728, one or more IMU sensors 2729, and/or any other types of sensors explained above or described with respect to any other embodiments discussed herein.

In some embodiments, peripherals interfaces 2722A and 2722B can include one or more additional peripheral devices, including one or more NFC devices 2730, one or more GPS devices 2731, one or more LTE devices 2732, one or more Wi-Fi and/or Bluetooth devices 2733, one or more buttons 2734 (e.g., including buttons that are slidable or otherwise adjustable), one or more displays 2735A and 2735B, one or more speakers 2736A and 2736B, one or more microphones 2737, one or more cameras 2738A and 2738B (e.g., including the left camera 2739A and/or a right camera 2739B), one or more haptic devices 2740, and/or any other types of peripheral devices defined above or described with respect to any other embodiments discussed herein.

AR systems can include a variety of types of visual feedback mechanisms (e.g., presentation devices). For example, display devices in AR system 2500 and/or VR system 2610 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 2735A and 2735B can be coupled to each of the lenses 2506-1 and 2506-2 of AR system 2500. Displays 2735A and 2735B may be coupled to each of lenses 2506-1 and 2506-2, which can act together or independently to present an image or series of images to a user. In some embodiments, AR system 2500 includes a single display 2735A or 2735B (e.g., a near-eye display) or more than two displays 2735A and 2735B. In some embodiments, a first set of one or more displays 2735A and 2735B can be used to present an augmented-reality environment, and a second set of one or more display devices 2735A and 2735B can be used to present a virtual-reality environment. In some embodiments, one or more waveguides are used in conjunction with presenting artificial-reality content to the user of AR system 2500 (e.g., as a means of delivering light from one or more displays 2735A and 2735B to the user's eyes). In some embodiments, one or more waveguides are fully or partially integrated into the eyewear device 2502. Additionally, or alternatively to display screens, some artificial-reality systems include one or more projection systems. For example, display devices in AR system 2500 and/or VR system 2610 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 2735A and 2735B.

Computing system 2720 and/or optional housing 2790 of AR system 2500 or VR system 2610 can include some or all of the components of a power system 2742A and 2742B. Power systems 2742A and 2742B can include one or more charger inputs 2743, one or more PMICs 2744, and/or one or more batteries 2745A and 2744B.

Memory 2750A and 2750B may include instructions and data, some or all of which may be stored as non-transitory computer-readable storage media within the memories 2750A and 2750B. For example, memory 2750A and 2750B can include one or more operating systems 2751, one or more applications 2752, one or more communication interface applications 2753A and 2753B, one or more graphics applications 2754A and 2754B, one or more AR processing applications 2755A and 2755B, and/or any other types of data defined above or described with respect to any other embodiments discussed herein.

Memory 2750A and 2750B also include data 2760A and 2760B, which can be used in conjunction with one or more of the applications discussed above. Data 2760A and 2760B can include profile data 2761, sensor data 2762A and 2762B, media content data 2763A, AR application data 2764A and 2764B, and/or any other types of data defined above or described with respect to any other embodiments discussed herein.

In some embodiments, controller 2746 of eyewear device 2502 may process information generated by sensors 2723A and/or 2723B on eyewear device 2502 and/or another electronic device within AR system 2500. For example, controller 2746 can process information from acoustic sensors 2525-1 and 2525-2. For each detected sound, controller 2746 can perform a direction of arrival (DOA) estimation to estimate a direction from which the detected sound arrived at eyewear device 2502 of R system 2500. As one or more of acoustic sensors 2725 (e.g., the acoustic sensors 2525-1, 2525-2) detects sounds, controller 2746 can populate an audio data set with the information (e.g., represented in FIG. 25 as sensor data 2762A and 2762B).

In some embodiments, a physical electronic connector can convey information between eyewear device 2502 and another electronic device and/or between one or more processors 2548, 2748A, 2748B of AR system 2500 or VR system 2610 and controller 2746. The information can be in the form of optical data, electrical data, wireless data, or any other transmittable data form. Moving the processing of information generated by eyewear device 2502 to an intermediary processing device can reduce weight and heat in the eyewear device, making it more comfortable and safer for a user. In some embodiments, an optional wearable accessory device (e.g., an electronic neckband) is coupled to eyewear device 2502 via one or more connectors. The connectors can be wired or wireless connectors and can include electrical and/or non-electrical (e.g., structural) components. In some embodiments, eyewear device 2502 and the wearable accessory device can operate independently without any wired or wireless connection between them.

In some situations, pairing external devices, such as an intermediary processing device (e.g., HIPD 1906, 2006, 2106) with eyewear device 2502 (e.g., as part of AR system 2500) enables eyewear device 2502 to achieve a similar form factor of a pair of glasses while still providing sufficient battery and computation power for expanded capabilities. Some, or all, of the battery power, computational resources, and/or additional features of AR system 2500 can be provided by a paired device or shared between a paired device and eyewear device 2502, thus reducing the weight, heat profile, and form factor of eyewear device 2502 overall while allowing eyewear device 2502 to retain its desired functionality. For example, the wearable accessory device can allow components that would otherwise be included on eyewear device 2502 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 2502 standing alone. Because weight carried in the wearable accessory device can be less invasive to a user than weight carried in the eyewear device 2502, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 2500 and/or VR system 2610 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 26A and 26B show VR system 2610 having cameras 2639A to 2639D, which can be used to provide depth information for creating a voxel field and a two-dimensional mesh to provide object information to the user to avoid collisions.

In some embodiments, AR system 2500 and/or VR system 2610 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 2500 and/or VR system 2610, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

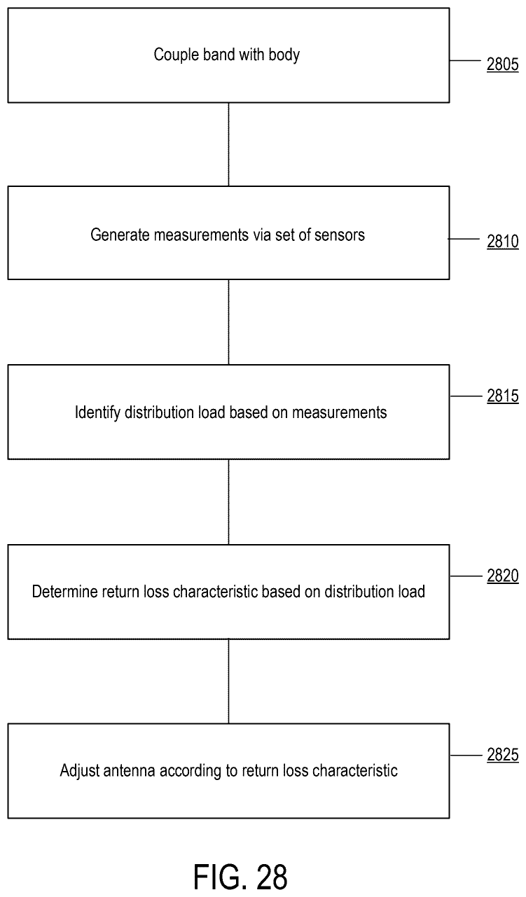

FIG. 28 illustrates an example method 2800 of a method for adjusting antenna performance in wearable devices based on detected load distribution. The method 2800 can be performed using processing circuitry, such as controller, which can be coupled with memory that stores instructions to perform acts or operations of the method. The method 2800 can be implemented using, or be combined with, any other functionalities or features discussed in connection with FIGS. 1-27. The method 2800 can include acts or operations 2805-2825. At 2805, the method can include coupling a band of a wearable device with a body of the wearable device. At 2810, the method can include generating measurements via a set of sensors. At 2815, the method can include identifying distribution load based on measurements. At 2820, the method can include determining return loss characteristics based on distributed load. At 2825, the method can include adjusting antenna operation according to return loss characteristics.

At 2805, the method can include coupling a band of a wearable device with a body of the wearable device. The method can include coupling a band of a wearable device with a body of the wearable device (e.g., a capsule). The body of the wearable device can include, utilize or be coupled with an antenna with the body. The antenna can include or be coupled with a transceiver and an impedance matching network that can include electrical components (e.g., resistor, capacitor and inductor circuitry) that can tune the operation or performance of the antenna. The body and the band can each include sensors for generating measurements indicative of interaction between the body and the band on the one side, and the body of the user on the other. For example, the band can be latched to the body with the smartwatch device using a mechanical coupling that completes an electrical connection between band sensors and the controller in the body. For example, a quick-release clasp can be used to couple the band to the body.

At 2810, the method can include generating measurements via a set of sensors. The method can include a set of sensors, which are supported by at least one of the body and the band, generating measurements indicative of interaction between a portion of a body of a user and the at least one of the body and the band. The set of sensors can include a plurality of sensors supported by both the interior surface the body facing the wrist of the user and by the interior surface of the band that is also facing the wrist of the user. The set of sensors can include at least one force sensor positioned to measure a force applied by the portion of the body of the user to at least one of the body and the band, at least one strain sensor coupled to the device body and configured to measure strain indicative of mechanical caused by the portion of the body of the user, or at least one tension sensor configured to measure a tension of the band when the wearable device is worn by the portion of the body of the user.

The set of sensors from the body and the band can provide sensor measurements to the controller, which can be housed within the body of the device. For example, force sensors on the inner surface of the capsule can detect increased pressure when the device is worn tightly during exercise. For example, tension sensors in the band can detect loosening when the clasp is partially disengaged, allowing the controller to record a low-load condition. The sensor measurements can be provided to the controller to use for adjusting performance or operation of the antenna according to the interaction between the device and the user's body. For example, the load distribution can indicate that an amount of force that is greater than a predetermined threshold is concentrated on the underside of the capsule when the user rests their wrist on a desk. For example, band strain readings can show an amount of tension that is higher than a predetermined threshold near one end of the clasp, corresponding to an uneven or tilted fit.

At 2815, the method can include identifying distribution load based on measurements. The method can include a controller, which is operably coupled with the set of sensors, identifying a distribution of load induced by the portion of the body of the user, based on the measurements from the set of sensors. The load distribution can correspond to the position, force, tension, compression or otherwise interaction between the body of the user and the smartwatch (e.g., body and/or the band). For example, a first sensor in the capsule can report a force that is higher than a threshold amount while a second sensor in the band can report less than a threshold amount of force, which can indicate asymmetric loading. For example, matching force values from body and band sensors can classify the profile as uniform loading suitable for a particular antenna configuration or setting.

The controller can identify the distribution of load by classifying the measurements into a loading profile. For instance, the loading profile can list, indicate or identify a first measurement of a first sensor of the set of sensors that is greater than a second measurement of a second sensor of the set of sensors. The first sensor can be supported by the body and the second sensor supported by the band. The controller can determine the load distribution based on the first measurement and the second measurement, including based on the difference between these measurements, or their added or combined amounts. For example, a measured profile consistent with a rigid phantom can correspond to a configuration that increases the antenna's resonant frequency. For example, a profile showing high tension across the band can correspond to a configuration that lowers resonance to counter increased dielectric loading.

The controller can map the distribution of load to a configuration of a plurality of configurations specifying a plurality of frequency responses of the antenna for a plurality of return loss characteristics. For instance, the controller can map the determined load distribution to a most closely matching configuration, by mapping the measurements from the set of sensors with data of different return loss characteristic profiles. Upon identifying the most closely matching configuration, the controller can select the matching configuration to use it for adjusting the operation of the antenna. For example, the configuration can correspond to one or more settings of one or more components of an impedance matching network to achieve a setting for a frequency response corresponding to the return loss characteristic identified based on the measurements from the set of sensors. For example, the impedance matching network can be set to particular capacitance, inductance, and resistance values to shift a particular LTE operating band. For example, the configuration can add or remove a stage in an impedance matching network, such as a capacitor or an inductor stage, to broaden bandwidth when operating in overlapping Wi-Fi channels.

The return loss characteristic can correspond to a frequency distribution of energy loss caused by the portion of the body of the user to the antenna. The configuration can define the one or more settings of components of the impedance matching network that include at least two of: a capacitor, an inductor, and a resistor. For example, the configuration can correspond to an RLC setting of a particular capacitance, resistance and/or inductance to apply to the transceiver or the antenna to offset the frequency response of the antenna to account for the return loss characteristics determined based on the measurements from the set of sensors. For example, the controller can retrieve a stored return-loss curve for a loose-fit profile detected during summer wear. For example, the stored association can be updated when a new exercise induced high load profile is measured.

At 2820, the method can include determining return loss characteristics based on distributed load. The method can include the controller determining a return loss characteristic of the antenna associated with the portion of the body of the user, based on the distribution of load. For example, the controller can determine the return loss characteristic by retrieving, from a memory, a stored association between the measurements and respective antenna return loss characteristics. The controller can be configured to update the stored association based on measurements acquired while a wearable device comprising the body and the band is worn by the user. For example, the controller can tune the antenna so the minimum of the return loss curve aligns with a frequency for Bluetooth communication. For example, the adjustment can target a frequency for a particular type of satellite signal reception.

The return loss characteristic can include a return loss curve of the antenna as a function of frequency. The controller can be configured to adjust the frequency response of the antenna by positioning a minimum value of the return loss curve within a predetermined operating band. The predetermined operating band can correspond to a wireless communication band of at least Cellular communication bands, Bluetooth communication bands, Wi-Fi communication bands, or GNSS bands. The controller can select an adjustment to the frequency response based on the predetermined operating band. For example, the controller can adjust the matching network to maintain performance when the watch is worn over clothing. For example, tuning can compensate for detuning detected after a wrist strap change by the user.

At 2825, the method can include adjusting antenna operation according to return loss characteristics. The method can include the controller adjusting a frequency response of the antenna according to the return loss characteristic. For instance, the method can include providing an impedance matching network of a tuner operatively coupled with the antenna. The impedance matching network can include a plurality of components (e.g., one or more RLC circuits comprising various arrangements of resistors, capacitors and/or inductors, which can be selected or activated via a switch network). The method can include the controller adjusting, via the impedance matching network of the tuner, the frequency response of the antenna to match a frequency response associated with the return loss characteristic.

The controller can select, from a plurality of configurations for the plurality of components, a configuration corresponding to the return loss characteristic. The method can include the controller applying the configuration to one or more components of the plurality of components of the impedance matching network to adjust the frequency response of the antenna according to the frequency response associated with the return loss characteristic. For example, the configuration can select certain switches to insert a parallel capacitance network that offsets the frequency response with respect to a particular operating band. For example, one or more switches can be engaged together to support a dual-band mode for concurrent GPS and Wi-Fi communication.

The method can include a second antenna, and the controller can select between the antenna and the second antenna to reduce absorption by the portion of the body of the user corresponding to the return loss characteristic. The controller can select between the two antennas responsive to the distribution of load, determined based on the measurements from the set of sensors. For example, the controller can activate the second antenna when load distribution shows tissue contact with the first antenna. For example, the system can switch to a band-integrated antenna when the capsule antenna experiences high absorption during wrist movements.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A system, comprising:
a band coupled with a body of a device;
an antenna operably coupled with the body;
a set of sensors supported by at least one of the body and the band, the set of sensors configured to generate measurements indicative of interaction between a portion of a body of a user and the at least one of the body and the band; and
a controller operably coupled with the set of sensors and configured to:
identify, based on the measurements, a distribution of load induced by the portion of the body of the user, corresponding to the interaction;
determine, based on the distribution of load, a return loss characteristic of the antenna associated with the portion of the body of the user; and
adjust a frequency response of the antenna according to the return loss characteristic.

2. The system of claim 1, further comprising:
a tuner operably coupled with the antenna; and
an impedance matching network of the tuner comprising a plurality of components to adjust the frequency response of the antenna to match a frequency response associated with the return loss characteristic.

3. The system of claim 2, wherein the controller is configured to:
select, from a plurality of configurations for the plurality of components, a configuration corresponding to the return loss characteristic; and
cause the configuration to be applied to one or more components of the plurality of components of the impedance matching network to adjust the frequency response of the antenna according to the frequency response associated with the return loss characteristic.

4. The system of claim 1, wherein the set of sensors is supported by the body and by the band and wherein the set of sensors comprises at least one force sensor positioned to measure a force applied by the portion of the body of the user to at least one of the body and the band.

5. The system of claim 4, wherein the set of sensors comprises at least one strain sensor coupled to the device body and configured to measure strain indicative of mechanical caused by the portion of the body of the user.

6. The system of claim 5, wherein the set of sensors comprises at least one tension sensor configured to measure a tension of the band when the wearable device is worn by the portion of the body of the user.

7. The system of claim 1, wherein the controller is configured to identify the distribution of load by classifying the measurements into a loading profile, the loading profile identifying a first measurement of a first sensor of the set of sensors that is greater than a second measurement of a second sensor of the set of sensors, the first sensor supported by the body and the second sensor supported by the band.

8. The system of claim 1, wherein the controller is further configured to map the distribution of load to a configuration of a plurality of configurations specifying a plurality of frequency responses of the antenna for a plurality of return loss characteristics, the configuration corresponding to one or more settings of one or more components of an impedance matching network to achieve a setting for a frequency response corresponding to the return loss characteristic.

9. The system of claim 8, wherein the return loss characteristic corresponds to a frequency distribution of energy loss caused by the portion of the body of the user to the antenna.

10. The system of claim 8, wherein the configuration defines the one or more settings of components of the impedance matching network that include at least two of: a capacitor, an inductor, and a resistor.

11. The system of claim 1, wherein the return loss characteristic comprises a return loss curve of the antenna as a function of frequency, and the controller is configured to adjust the frequency response of the antenna by positioning a minimum value of the return loss curve within a predetermined operating band.

12. The system of claim 11, wherein the predetermined operating band corresponds to a wireless communication band of at least Cellular communication bands, Bluetooth communication bands, Wi-Fi communication bands, or GNSS bands, and the controller is configured to select an adjustment to the frequency response based on the predetermined operating band.

13. The system of claim 1, further comprising a second antenna, wherein the controller is configured to, responsive to the distribution of load, select between the antenna and the second antenna to reduce absorption by the portion of the body of the user corresponding to the return loss characteristic.

14. The system of claim 1, wherein the controller is configured to determine the return loss characteristic by retrieving, from a memory, a stored association between the measurements and respective antenna return loss characteristics.

15. The system of claim 14, wherein the controller is configured to update the stored association based on measurements acquired while a wearable device comprising the body and the band is worn by the user.

16. A method, comprising:
coupling a band with a body of a device that is coupled with an antenna with the body;
generating, by a set of sensors supported by at least one of the body and the band, measurements indicative of interaction between a portion of a body of a user and the at least one of the body and the band;
identifying, by a controller operably coupled with the set of sensors, based on the measurements, a distribution of load induced by the portion of the body of the user, corresponding to the interaction;
determining, by the controller, based on the distribution of load, a return loss characteristic of the antenna associated with the portion of the body of the user; and
adjusting, by the controller, a frequency response of the antenna according to the return loss characteristic.

17. The method of claim 16, further comprising:
providing an impedance matching network of a tuner operatively coupled with the antenna, the impedance matching network comprising a plurality of components; and
adjusting, via the impedance matching network of the tuner, the frequency response of the antenna to match a frequency response associated with the return loss characteristic.

18. The method of claim 17, comprising:
selecting, by the controller, from a plurality of configurations for the plurality of components, a configuration corresponding to the return loss characteristic; and
applying, by the controller, the configuration to one or more components of the plurality of components of the impedance matching network to adjust the frequency response of the antenna according to the frequency response associated with the return loss characteristic.

19. The method of claim 16, wherein the set of sensors is supported by the body and by the band and wherein the set of sensors comprises at least one force sensor positioned to measure a force applied by the portion of the body of the user to at least one of the body and the band.

20. A non-transitory computer-readable media storing instructions, which when executed by one or more processors, cause the one or more processors to:
receive, by a controller from a set of sensors supported by at least one of a body of a device coupled with a band that is operably coupled with an antenna, measurements that are indicative of interaction between a portion of a body of a user and the at least one of the body and the band; and
identify, by the controller, based on the measurements, a distribution of load induced by the portion of the body of the user, corresponding to the interaction;
determine, by the controller, based on the distribution of load, a return loss characteristic of the antenna associated with the portion of the body of the user; and
adjust, by the controller, a frequency response of the antenna according to the return loss characteristic.
